(19) United States
(12) Patent Application Publication
(10) Pub. No.: US 2026/0034442 A1
(43) Pub. Date: Feb. 5, 2026

(54) GAME PICTURE DISPLAY

(71) Applicant: TENCENT TECHNOLOGY (SHENZHEN) COMPANY LIMITED, Shenzhen (CN)

(72) Inventor: Jieqi XIE, Shenzhen (CN)

(73) Assignee: TENCENT TECHNOLOGY (SHENZHEN) COMPANY LIMITED, Shenzhen (CN)

(21) Appl. No.: 19/350,910

(22) Filed: Oct. 6, 2025

Related U.S. Application Data
(63) Continuation of application No. PCT/CN2024/136274, filed on Dec. 3, 2024.

(30) Foreign Application Priority Data
Jan. 2, 2024 (CN) 202410014562.5

(51) Int. Cl. A63F 13/52; A63F 13/44; A63F 13/533; A63F 13/56

(52) U.S. Cl. CPC A63F 13/52; A63F 13/44; A63F 13/533; A63F 13/56

(57) ABSTRACT

In a game picture display method, a virtual game interface of a virtual game is displayed on a client interface. A first picture is displayed on the virtual game interface. The first picture corresponds to a first game picture frame of the virtual game. Based on a window display request triggered on the virtual game interface, the virtual game interface displayed on the client interface is replaced with a game floating window on the client interface. A display area of the game floating window is smaller than a display area of the virtual game interface. A second picture is displayed, by processing circuitry, in the game floating window. The second picture includes a resized rendition of a second game picture frame of the virtual game and a key information indicator overlaid on the resized rendition. The key information indicator indicates a game process of the virtual game.

### RELATED APPLICATIONS

The present application is a continuation of International Application No. PCT/CN2024/136274, filed on Dec. 3, 2024, which claims priority to Chinese Patent Application No. 202410014562.5, entitled “GAME PICTURE DISPLAY METHOD AND APPARATUS, STORAGE MEDIUM, AND ELECTRONIC DEVICE,” filed on Jan. 2, 2024. The entire disclosures of the prior applications are hereby incorporated by reference.

### FIELD OF THE TECHNOLOGY

This disclosure relates to the field of computers, including a game picture display technology.

### BACKGROUND OF THE DISCLOSURE

In a game picture display process, there is often an idle process of long-time waiting for a player, for example, a scene of waiting for another player to play a card in a chess and card game. However, in these idle processes, attractiveness of display content of a game picture on a player and information transmission efficiency significantly decrease. In some scenarios, the validity of the displayed game picture is degraded.

To solve the issue of low display validity, some users choose to switch to another application interface to kill time. However, this operation can cause the game picture to be displayed not timely enough, and the user may miss a critical moment in the game, for example, a moment of playing a card.

As can be seen, in the game picture display process, validity and timeliness of displaying of a game picture may need to be balanced. Therefore, there is a problem regarding balancing the validity and the timeliness of the displaying of the game picture.

For the above problem, no effective solution has been provided yet.

### SUMMARY

Embodiments of this disclosure provide a game picture display method and apparatus, a storage medium, and an electronic device, to at least solve a technical problem regarding balancing the validity and timeliness of displaying of a game picture.

According to one aspect of the embodiments of this disclosure, a game picture display method is provided. In the method, a virtual game interface of a virtual game is displayed on a client interface. A first picture is displayed on the virtual game interface. The first picture corresponds to a first game picture frame of the virtual game. Based on a window display request triggered on the virtual game interface, the virtual game interface displayed on the client interface is replaced with a game floating window on the client interface. A display area of the game floating window is smaller than a display area of the virtual game interface. A second picture is displayed, by processing circuitry, in the game floating window. The second picture includes a resized rendition of a second game picture frame of the virtual game and a key information indicator overlaid on the resized rendition. The key information indicator indicates a game process of the virtual game.

According to one aspect of the embodiments of this disclosure, a game picture display apparatus is provided. The game picture display apparatus includes processing circuitry configured to display a virtual game interface of a virtual game on a client interface. The processing circuitry is configured to display a first picture on the virtual game interface. The first picture corresponds to a first game picture frame of the virtual game. The processing circuitry is configured to replace, based on a window display request triggered on the virtual game interface, the virtual game interface displayed on the client interface with a game floating window on the client interface. A display area of the game floating window is smaller than a display area of the virtual game interface. The processing circuitry is configured to display a second picture in the game floating window. The second picture includes a resized rendition of a second game picture frame of the virtual game and a key information indicator overlaid on the resized rendition. The key information indicator indicates a game process of the virtual game.

According to one aspect of the embodiments of this disclosure, a non-transitory computer-readable storage medium is provided. The non-transitory computer-readable storage medium stores instructions, which when executed by a processor, cause the processor to perform displaying a virtual game interface of a virtual game on a client interface. The instructions, which when executed by the processor, cause the processor to perform displaying a first picture on the virtual game interface. The first picture corresponds to a first game picture frame of the virtual game. The instructions, which when executed by the processor, cause the processor to perform replacing, based on a window display request triggered on the virtual game interface, the virtual game interface displayed on the client interface with a game floating window on the client interface. A display area of the game floating window is smaller than a display area of the virtual game interface. The instructions, which when executed by the processor, cause the processor to perform displaying a second picture in the game floating window. The second picture includes a resized rendition of a second game picture frame of the virtual game and a key information indicator overlaid on the resized rendition. The key information indicator indicates a game process of the virtual game.

According to one aspect of the embodiments of this disclosure, a game picture display method is provided, which is performed by an electronic device and including: displaying a virtual game interface on a client interface, and displaying a first picture on the virtual game interface, the virtual game interface being a display interface of a virtual game, and the first picture being a game picture of the virtual game; and replacing, in response to a window display request triggered on the virtual game interface, the virtual game interface displayed on the client interface with a game floating window, and displaying a second picture in the game floating window, a display area of the game floating window being smaller than a display area of the virtual game interface, the second picture including the first picture and key information of the virtual game, and the key information being configured for prompting a game process of the virtual game.

According to another aspect of the embodiments of this disclosure, a game picture display apparatus is provided, which is deployed on an electronic device and including: a first display unit, configured to: display a virtual game interface on a client interface, and display a first picture on the virtual game interface, the virtual game interface being a display interface of a virtual game, and the first picture being a game picture of the virtual game; and a second display unit, configured to: replace, in response to a window display request triggered on the virtual game interface, the virtual game interface displayed on the client interface with a game floating window, and display a second picture in the game floating window, a display area of the game floating window being smaller than a display area of the virtual game interface, the second picture including the first picture and key information of the virtual game, and the key information being configured for prompting a game process of the virtual game.

According to still another aspect of the embodiments of this disclosure, a non-transitory computer-readable storage medium is provided. The non-transitory computer-readable storage medium includes a stored computer program. The computer program, when executed by an electronic device, causes the electronic device to perform the above game picture display method.

According to yet another aspect of the embodiments of this disclosure, a computer program product is provided, including a computer program, the computer program being stored in a non-transitory computer-readable storage medium. A processor of an electronic device reads the computer program from the non-transitory computer-readable storage medium, and executes the computer program, to cause the electronic device to perform the above game picture display method.

According to still yet another aspect of the embodiments of this disclosure, an electronic device is further provided, including a memory, processing circuitry such as a processor, and a computer program stored in the memory and capable of being executed on the processor. The processor performs the game picture display method through the computer program.

In the embodiments of this disclosure, the virtual game interface is displayed on the client interface, and the first picture is displayed on the virtual game interface. The virtual game interface is the display interface of the virtual game, and the first picture is a game picture of the virtual game. If a player intends to switch to another application interface or exit the virtual game interface, the player may trigger the window display request to avoid missing a critical moment in the virtual game, thus replacing, in response to the window display request triggered on the virtual game interface, the virtual game interface displayed on the client interface with the game floating window, and displaying the second picture in the game floating window. The display area of the game floating window is smaller than the display area of the virtual game interface. The second picture includes the first picture and the key information of the virtual game. The key information is configured for prompting the game process of the virtual game. The manner of replacing the virtual game interface with the game floating window may still display the game picture of the virtual game when the player switches to another application interface or exits the virtual game interface. Compared with picture displaying on the virtual game interface, the player may autonomously determine displaying of another effective picture based on the displaying of the game floating window. In this way, even if attractiveness of display content of the game picture on the player decreases, that the player determines the another effective picture can still further facilitate valid information transfer efficiency. Meanwhile, this embodiment also facilitate that the player can still accurately and intuitively obtain, from the game floating window, valuable key information in the virtual game during the displaying of the game floating window with reference to a main game picture and key information, thus ensuring transferring of valid information while displaying the game picture in the game floating window, and also ensuring timely displaying of the valuable key information in the virtual game. Thus, a technical effect of balancing display validity and display timeliness of the game picture is achieved, and the technical problem that the validity and the timeliness of displaying of the game picture cannot be balanced is solved.

### BRIEF DESCRIPTION OF THE DRAWINGS

The accompanying drawings described herein are used to provide a further understanding of this disclosure, and form part of this disclosure. Embodiments of this disclosure and descriptions thereof are used to explain this disclosure, and do not constitute any limitation to this disclosure. In the accompanying drawings:

FIG. 1 is a schematic diagram of an application environment of a game picture display method according to an embodiment of this disclosure.

FIG. 2 is a schematic flowchart of a game picture display method according to an embodiment of this disclosure.

FIG. 3 is a schematic diagram of a game picture display method according to an embodiment of this disclosure.

FIG. 4 is a schematic diagram of a game picture display method according to another embodiment of this disclosure.

FIG. 5 is a schematic diagram of a game picture display method according to another embodiment of this disclosure.

FIG. 6 is a schematic diagram of a game picture display method according to another embodiment of this disclosure.

FIG. 7 is a schematic diagram of a game picture display method according to another embodiment of this disclosure.

FIG. 8 is a schematic diagram of a game picture display method according to another embodiment of this disclosure.

FIG. 9 is a schematic diagram of a game picture display method according to another embodiment of this disclosure.

FIG. 10 is a schematic diagram of a game picture display method according to another embodiment of this disclosure.

FIG. 11 is a schematic diagram of a game picture display method according to another embodiment of this disclosure.

FIG. 12 is a schematic diagram of a picture display method according to another embodiment of this disclosure.

FIG. 13 is a schematic diagram of a game picture display method according to another embodiment of this disclosure.

FIG. 14 is a schematic diagram of a game picture display method according to another embodiment of this disclosure.

FIG. 15 is a schematic diagram of a game picture display method according to another embodiment of this disclosure.

FIG. 16 is a schematic diagram of a game picture display method according to another embodiment of this disclosure.

FIG. 17 is a schematic diagram of a game picture display method according to another embodiment of this disclosure.

FIG. 18 is a schematic diagram of a game picture display method according to another embodiment of this disclosure.

FIG. 19 is a schematic diagram of a game picture display method according to another embodiment of this disclosure.

FIG. 20 is a schematic diagram of a game picture display method according to another embodiment of this disclosure.

FIG. 21 is a schematic diagram of a game picture display apparatus according to an embodiment of this disclosure.

FIG. 22 is a schematic structural diagram of an electronic device according to an embodiment of this disclosure.

### DESCRIPTION OF EMBODIMENTS

Examples of technical solutions in embodiments of this disclosure are described below with reference to the accompanying drawings. The described embodiments are merely some rather than all of the embodiments of this disclosure. Other embodiments are within the scope of the disclosure

The terms “first”, “second”, etc. in the specification and claims of this disclosure and the above accompanying drawings are defined to distinguish similar objects, and do not have to be used to describe a specific order or sequence. Such used data is interchangeable where appropriate, so that the embodiments of this disclosure described here can be implemented in an order other than those illustrated or described here. In addition, the terms “include” and “have”, as well as any variations thereof, are intended to cover non-exclusive inclusion. For example, a process, method, system, product, or equipment that includes a series of operations or units does not need to be limited to those listed operations or units, but may include other operations or units not listed or inherent to these processes, methods, products, or equipment.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

For ease of understanding, the following nouns are explained:

Auto battler may correspond to a type of a tactical electronic game, and usually has elements similar to chess. It is also an SRPG in a sense. In a preparation stage, a player places characters on a grid-shaped battle field, and then the characters automatically fight against each other. The player usually does not need to perform a further enter operation.

Small window/floating window small screen: in a small window mode, a level is located at a top of an interface. When a user operates an application, the user may perform other operations and browsing on a small window at the same time.

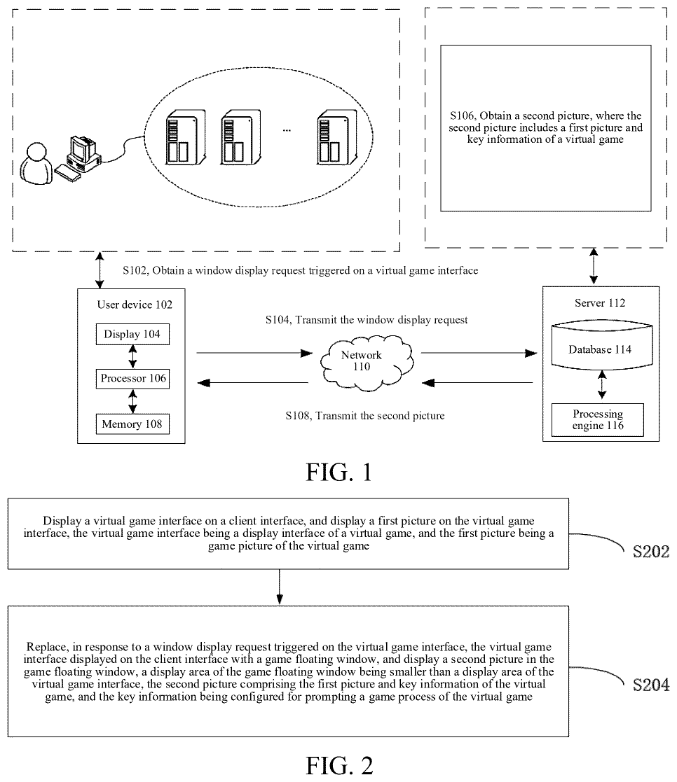

According to one aspect of the embodiments of this disclosure, a game picture display method is provided. In some embodiments, as a non-limiting example, the above game picture display method may be applied to, but is not limited to, an environment shown in FIG. 1. The implementation environment may include, but is not limited to, a user device 102 and a server 112. The user device 102 may include, but is not limited to, a display 104, a processor 106, and a memory 108. The server 112 includes a database 114 and a processing engine 116.

Specific processes are as following operations.

Operation S102: A user device 102 displays a virtual game interface on a client interface, displays a first picture on the virtual game interface, and further obtains a window display request triggered on the virtual game interface, the window display request being configured for requesting to display a game picture of a virtual game through a game floating window.

Operation S104: The window display request is transmitted to a server 112 through a network 110.

Operation S106: The server 112 further obtains a second picture in response to the window display request through a processing engine 116, the second picture including the first picture and key information of the virtual game.

Operation S108: The second picture is transmitted to the user device 102 through the network 110. The user device 102 displays the second picture in the game floating window of a display 104 through a processor 106, thus replacing the virtual game interface. The second picture is stored into a memory 108.

In addition to the example shown in FIG. 1, the above terminal device may be a terminal device configured with a target client, and may include, but is not limited to, at least one of the following: a mobile phone (e.g., an Android mobile phone and an iOS mobile phone), a notebook computer, a tablet computer, a palm computer, a mobile Internet device (MID), a PAD, a desk computer, an intelligent television, and the like. The target client may be a video client, an instant messaging client, a browser client, an education client, or the like. The network may include, but is not limited to: a wired network and a wireless network. The wired network includes a local area network, a metropolitan area network, and a wide area network. The wireless network includes Bluetooth, WIFI, and other networks implementing wireless communication. The foregoing server may be one server, a server cluster formed by a plurality of servers, or a cloud server. The above description is merely an example. This is not limited in any way in this embodiment.

In some embodiments, as a non-limiting example, as shown in FIG. 2, the game picture display method may be performed by an electronic device. The electronic device may be, for example, the user device or the server shown in FIG. 1. Specific operations include:

S202: Display a virtual game interface on a client interface, and display a first picture on the virtual game interface, the virtual game interface being a display interface of a virtual game, and the first picture being a game picture of the virtual game. In one example, a virtual game interface of a virtual game is displayed on a client interface. A first picture is displayed on the virtual game interface, where the first picture corresponds to a first game picture frame of the virtual game.

S204: Replace, in response to a window display request triggered on the virtual game interface, the virtual game interface displayed on the client interface with a game floating window, and display a second picture in the game floating window, a display area of the game floating window being smaller than a display area of the virtual game interface, the second picture including the first picture and key information of the virtual game, and the key information being configured for prompting a game process of the virtual game. In one example, based on a window display request triggered on the virtual game interface, the virtual game interface displayed on the client interface is replaced with a game floating window on the client interface. A display area of the game floating window is smaller than a display area of the virtual game interface. In one example, a second picture is displayed in the game floating window by processing circuitry. The second picture includes a resized rendition of a second game picture frame of the virtual game and a key information indicator overlaid on the resized rendition. The key information indicator indicates a game process of the virtual game.

In some embodiments, the game picture display method may be applied to, but is not limited to, a multiplayer arena game scene, such as a multiplayer online battle arena (MOBA) game scene. A player usually has waiting time that cannot be skipped. Within this period of time, a player may feel that attractiveness of display content of a game picture decreases and information transfer efficiency decreases, namely, there is a problem of low display validity. To help players better spend this waiting time, some players choose to switch to another application interface. However, by doing this, they may miss critical moments in the game, for example, start of team fight or completion of cooldown of an important skill.

However, in this embodiment, to solve the above problem, when a player exits the virtual game interface, or switches to another application interface, in this embodiment, the game floating window may be displayed on the client interface. An area of the game floating window may be smaller than the display area of the virtual game interface. In addition, the second picture may be displayed in the game floating window. The second picture includes a main picture (i.e. the first picture) of a current virtual game and key information of the virtual game (for example, in a form of a key information indicator), such as skill cooldown time and teammate revival progress. In this way, even during waiting, the player can quickly see the key information, thus making a better decision. Meanwhile, because the key information is presented in one game floating window, the player does not need to worry about missing an important moment.

In some embodiments, the client interface may be understood as a bottom-layer interface run on a user terminal (such as a mobile phone or a computer). When a virtual game, a browser, a social media application, or any other application is started, the virtual game, the browser, the social media application, or any other application may be displayed on the client interface. In other words, the client interface is a basis for interaction between a user and an application.

A relationship between the client interface and the virtual game interface is that the client interface is located at a bottom layer. The client interface is the basis for interaction between the user and the application. As a part of the virtual game, the virtual game interface may be displayed on the client interface. However, the virtual game interface is a specific scene or environment in the virtual game.

In some embodiments, the game floating window may be, but is not limited to, displayed after the player exits the virtual game interface. This means that when the player returns from the virtual game interface to a main screen (the client interface) of a device or to another application, the game floating window still stays on the client interface and displays information related to the virtual game. While not interfering a main game experience of the player, the game floating window may provide additional information or functions and have a small display area, so as not to completely block the main game interface, thereby ensuring that the player can pay attention to content on the client interface and in the floating window. In addition, the game floating window may alternatively have interactivity. For example, the player may perform some quick operations or settings in the game floating window, without switching to another interface.

In a further example, in some embodiments, it is assumed that a player is playing a strategy game and may need to wait for completion of upgrade of a building. It is estimated that it will take several minutes. Within this period of time, the player may hope to temporarily exit the virtual game interface to view social media, reply messages, or do other things. When the player exits the virtual game interface, the game floating window may be automatically displayed. The game floating window has a moderate size, and does not block other applications or important content on the main screen. In the game floating window, the player can see a real-time picture of the virtual game, including a building that is being upgraded, a surrounding environment, and activities of other players.

In addition, the game floating window further displays some key information, for example, an upgrade progress of the building, remaining time, and other possible prompts (for example, an enemy approaches or there are new tasks). In this way, while handling other transactions, the player can still master latest events of the virtual game at any time through the game floating window. When the upgrade of the building is completed or another important event occurs, the game floating window may further prompt the player in a flashing manner, by voice, or in another manner. In this way, the player may not miss any important moment even if the player temporarily leaves the virtual game.

In some embodiments, the key information may be, but is not limited to, data or knowledge that is crucial for achieving a purpose or making a decision in a particular scene, such as information that can affect a player's decision or a game process. Skill cooldown time, revival time, a hit point of a character, a mana value, an equipment state, a position of a teammate or an enemy, an action state of a teammate or an enemy, a game target, a task progress prompt, an important mark or event on a map, and the like may be displayed in the game floating window as the key information.

Through the game floating window, the player can still view a game picture when exiting the virtual game interface or switching to another application. Compared with a complete virtual game interface, the game floating window allows the player to view other content at the same time, thereby maintaining information transfer efficiency. The game floating window combines the game picture with the key information, to provide that the player can quickly obtain valuable information in the virtual game. In this way, this embodiment not only facilitates valid information transfer, but also provides timely displaying of the key information, so that display validity and display timeliness of the game picture are balanced, thereby enhancing a game experience.

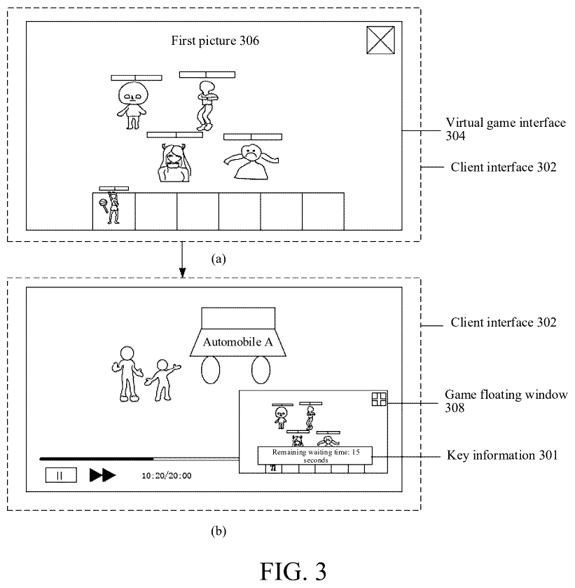

Further, for example, in some embodiments, as shown in FIG. 3(a), a virtual game interface 304 is displayed on a client interface 302, and a first picture 306 is displayed on the virtual game interface 304. The virtual game interface 304 is a display interface of a virtual game, and the first picture 306 is a game picture of the virtual game. Further as shown in FIG. 3(b), in response to a window display request triggered on the virtual game interface 304, a game floating window 308 is displayed on the client interface 302, and a second picture is displayed in the game floating window 308. A display area of the game floating window 308 is smaller than a display area of the virtual game interface 304. The second picture includes the first picture 306 and key information 310 of the virtual game, and the key information 310 is configured for prompting a game process of the virtual game, such as “Remaining waiting time is 15 seconds”.

In this embodiment provided by this disclosure, the virtual game interface is displayed on the client interface, and the first picture is displayed on the virtual game interface. The virtual game interface is the display interface of the virtual game, and the first picture is the game picture of the virtual game. If the player intends to switch to another application interface or exit the virtual game interface, the player may trigger the window display request to avoid missing a critical moment in the virtual game, thus replacing, in response to the window display request triggered on the virtual game interface, the virtual game interface displayed on the client interface with the game floating window, and displaying the second picture in the game floating window. The display area of the game floating window is smaller than the display area of the virtual game interface. The second picture includes the first picture and the key information of the virtual game. The key information is configured for prompting the game process of the virtual game. The manner of replacing the virtual game interface with the game floating window may still display the game picture of the virtual game when the player switches to another application interface or exits the virtual game interface. Compared with picture displaying on the virtual game interface, the player may autonomously determine displaying of another effective picture based on the displaying of the game floating window. In this way, even if attractiveness of display content of the game picture on the player decreases, that the player determines the another effective picture can still provide valid information transfer efficiency. Meanwhile, this embodiment also provides that the player can still accurately and intuitively obtain, from the game floating window, valuable key information in the virtual game during the displaying of the game floating window with reference to a main game picture and key information, thus ensuring transferring of valid information while displaying the game picture in the game floating window, and also ensuring timely displaying of the valuable key information in the virtual game. Thus, a technical effect of balancing display validity and display timeliness of the game picture is achieved.

As a non-limiting example, the displaying a second picture in the game floating window includes:

displaying the first picture and process prompt information in the game floating window, the process prompt information being configured for prompting a running condition of at least one sub-process in the virtual game, and the key information including the process prompt information. In one example, the key information indicator includes process prompt information indicating a running condition of at least one sub-process in the virtual game.

In some embodiments, the process prompt information may be, but is not limited to, key information displayed in the game floating window, and is configured for prompting a player of a running condition of at least one sub-process in the virtual game. Each sub-process may be a task, a dungeon, and an activity in the game, or other content related to the game process.

In a further example, in some embodiments, a completion progress of a current sub-process is displayed, for example, a completion percentage of a task that has been completed, or a finishing percentage of a dungeon. This can help players learn their progress in the virtual game and how much the players may need to complete to achieve a goal.

If a sub-process has a time limitation, for example, if there is a time-limited task or activity, remaining time may be displayed in the process prompt information. This can help players manage their time and enable that they can complete the task or activity in time.

However, in a multiplayer game, the process prompt information may possibly display a state of a teammate or a team member, for example, a health point, a mana value, whether the teammate or the team member is online, whether the teammate or the team member is ready, or the like. This can help players better coordinate team actions and improve team cooperation efficiency.

In addition, in some cases, the process prompt information may highlight a moment at which a player may need to make a key decision, for example, the player chooses to launch an attack or carry out a defense in a strategy game, or the player selects a dialog option in a role play game. This can help players to better understand a game situation and make a better decision. Based on a specific design of the virtual game, the process prompt information may further include other information related to the current sub-process, for example, a specific game rule, a condition, a reward, and the like.

In this embodiment, by displaying the second picture in the game floating window, a player can manage time and attention more effectively, and can keep paying attention to the virtual game while handling another transaction, thereby improving efficiency and quality of a game experience. In addition, since the second picture includes the process prompt information, efficiency of managing a sub-process in the virtual game is improved, and a decision and a response can be made more quickly, thereby achieving better performance in the virtual game.

In a further example, in some embodiments, it is assumed that a player is playing a massive multiplayer online role-playing game (MMORPG), and there is an important team dungeon in the virtual game being played. Since dungeon time is long, the player decides to temporarily exit the virtual game interface to handle some other transactions. In this case, the game floating window may display the second picture, including: the first picture displaying a real-time condition of the team dungeon, and the process prompt information displaying the key information such as a progress of the dungeon, remaining time, and a teammate state.

Based on this embodiment provided by this disclosure, the first picture and the process prompt information are displayed in the game floating window. The process prompt information is configured for prompting the running condition of the at least one sub-process in the virtual game, and the key information includes the process prompt information, thereby improving efficiency of managing a sub-process in the virtual game and achieving the technical effect of balancing the display validity and the display timeliness of the game picture.

As a non-limiting example, the displaying the first picture and process prompt information in the game floating window includes (not shown in the figure):
S1-1: display the first picture and first process information in the game floating window, the first process information being configured for prompting a stage and round to which a currently run sub-process of the virtual game belongs, and the process prompt information including the first process information (for example, the process prompt information includes first process information indicating a stage and a round to which a currently run sub-process of the virtual game belongs); or
S1-2: display the first picture and first time information in the game floating window, the first time information being configured for prompting remaining process time before the currently run sub-process of the virtual game ends (for example, the process prompt information includes first time information indicating a remaining process time before the currently run sub-process of the virtual game ends); or
S1-3: display the first picture, second process information, and second time information in the game floating window, the second process information being configured for prompting a stage and round to which the currently run sub-process of the virtual game belongs, and the second time information being configured for prompting a remaining stage time before the stage ends, or a remaining round time before the round ends (for example, the process prompt information includes second process information indicating a stage and a round to which the currently run sub-process of the virtual game belongs, and second time information indicating a remaining stage time before the stage ends, or a remaining round time before the round ends); or
S1-4: display the first picture, third process information, and third time information in the game floating window, the third process information being configured for prompting that the currently run sub-process of the virtual game belongs to a specified game event, and the third time information being configured for prompting remaining event time before the specified game event ends (for example, the process prompt information includes third process information indicating a game event to which the currently run sub-process of the virtual game belongs, and third time information indicating a remaining event time before the game event ends).

In some embodiments, the first picture and the first process information are simultaneously displayed in the floating window. The first process information informs a player of the stage and round to which the currently run sub-process belongs. For example, in a strategy game, a player is playing a battle including a plurality of rounds. When the player temporarily exits the game, the game floating window may display which round and in which stage of the battle is being currently performed. If a first round of a first stage of the battle is being performed, the first process information may prompt that the currently run sub-process is in the first round of the first stage.

In some embodiments, the game floating window displays the first picture and the first time information. The first time information prompts the player of the remaining time before the currently run sub-process ends. For example, in a time-limited task, the game floating window may display total time from a start to an end of the task, and current remaining time.

In some embodiments, the game floating window displays the first picture, the second process information, and the second time information. The second process information informs a player of the stage and round to which the currently run sub-process belongs, and the second time information is configured for prompting the remaining stage time before the stage ends, or the remaining round time before the round ends, namely, prompting the remaining time before the stage or round ends. This is applicable to more complex and phased tasks or activities.

In some embodiments, the game floating window displays the first picture, the third process information, and the third time information. The third process information prompts a player that the currently run sub-process is related to a specific game event, and the third time information displays remaining time before the event ends. For example, in an MMORPG, a floating window may display start time and end time of a world BOSS battle, and a current progress of the battle.

When a player switches to another application or exits the virtual game interface in the game, the game floating window may display various information related to a current game process, to help the player better understand and manage a sub-process in the game. By displaying the detailed information in the game floating window, the player can manage time and attention of the player more effectively, and keep deep participation in the virtual game. The player may adjust a strategy, make a decision, interact with another player, and so on based on information displayed in the game floating window, thereby achieving a more efficient and more targeted game experience, and achieving a technical effect of balancing continuity and validity of the game experience at a plurality of levels.

For example, in some embodiments, it is assumed that a player is playing a card battle game and is playing a tournament including three stages. When the player exits the virtual game interface, the game floating window may display a third round of a second stage among the three stages being currently performed. The second stage includes five rounds in total, and there are still two minutes left. In this way, the player can quickly learn about a current state of the virtual game and make a corresponding decision.

In this embodiment provided by this disclosure, the first picture and first process information are displayed in the game floating window, where the first process information is configured for prompting that the currently run sub-process of the virtual game belongs to the first round of the first stage, and the process prompt information includes the first process information; or the first picture and the first time information are displayed in the game floating window, where the first time information is configured for prompting the remaining process time before the currently run sub-process of the virtual game ends; or the first picture, the second process information, and the second time information are displayed in the game floating window, where the second process information is configured for prompting the stage and round to which the currently run sub-process of the virtual game belongs, and the second time information is configured for prompting the remaining stage time before the stage ends, or the remaining round time before the round ends; or the first picture, the third process information, and the third time information are displayed in the game floating window, where the third process information is configured for prompting that the currently run sub-process of the virtual game belongs to the specified game event, and the third time information is configured for prompting remaining event time before the specified game event ends. Thus, the more efficient and more targeted game experience is achieved, and the technical effect of balancing the continuity and the validity of the game experience at a plurality of levels is achieved.

As a non-limiting example, the replacing the virtual game interface displayed on the client interface with a game floating window, and displaying a second picture in the game floating window includes (not shown in the figure):
S2-1: display a game floating window in a small window mode on the client interface, and display, in the game floating window in the small window mode, the key information and a first picture that remains static, the first picture that remains static being one of a plurality of frames of game pictures in which the virtual game is continuously played (for example, based on the game floating window being in a small window mode, the key information indicator and a static picture corresponding to one of a plurality of game picture frames of the virtual game are displayed in the game floating window); or
S2-2: display a game floating window in a large window mode on the client interface, and display the key information and a dynamically played first picture in the game floating window in the large window mode, the dynamically played first picture including the plurality of frames of game pictures (for example, based on the game floating window being in a large window mode, the key information indicator and a video clip corresponding to a resized rendition of the plurality of game picture frames are displayed in the game floating window).

When a player may need to display the game floating window on the client interface during gaming, there are two main display modes (the small window mode and the large window mode). In each mode, content displayed in and display manners of the game floating window are different.

However, by displaying the game floating window on the client interface and with reference to the display manners of the key information and the game picture in different modes, the player can still pay attention to and participate in the virtual game while processing another task, thereby improving multitasking efficiency and enabling the player to better balance a relationship between the virtual game and another activity. Meanwhile, based on the dynamically played first picture, the player can learn about a real-time state of the virtual game more intuitively and make a more accurate decision and response. This comprehensive display manner achieves a technical effect of balancing a game experience and task processing efficiency on the client interface.

In some embodiments, in the small window mode of this embodiment, the game floating window is displayed on the client interface in a relatively small size. The key information may be displayed in the game floating window, usually including important prompts or states related to the game process. Meanwhile, the first picture remains static, which means that one of the plurality of frames of game pictures in which the virtual game is continuously played is displayed.

For example, in some embodiments, when playing a role play game, a player may need to continuously detect an auction house event in the game while browsing a web page. The game floating window is displayed beside a browser in the small window mode, to display key information such as a state of a current auction house and remaining time. In addition, the game floating window further displays a static game picture, so that the player can quickly learn about a current visual state of the game.

In some embodiments, in the large window mode of this embodiment, the game floating window is displayed on the client interface in a relatively large size. In addition to displaying the key information, the floating window can further dynamically play the first picture, namely, a continuous animation including a plurality of frames of game pictures.

For example, in some embodiments, when playing an instant strategy game, a player may need to observe a battle field in the game while writing a document. The game floating window is displayed beside a document editor in the large window mode, to display key information such as a real-time dynamic situation of the battle field and a resource condition. In addition, the game floating window further displays a dynamically played game picture, so that the player can see a real-time change of the battle field.

In this embodiment provided by this disclosure, the game floating window in the small window mode is displayed on the client interface, and the key information and the first picture that remains static are displayed in the game floating window in the small window mode, where the first picture that remains static is one of the plurality of frames of game pictures in which the virtual game is continuously played; or the game floating window in the large window mode is displayed on the client interface, and the key information and the dynamically played first picture are displayed in the game floating window in the large window mode, where the dynamically played first picture includes the plurality of frames of game pictures. Thus, a purpose of displaying the key information and the game picture in different modes is achieved, and the technical effect of balancing the game experience and the task processing efficiency on the client interface is achieved.

As a non-limiting example, after the displaying a game floating window in a small window mode on the client interface, and displaying, in the game floating window in the small window mode, the key information and a first picture that remains static, the method further includes: displaying, in response to an enlarge adjustment operation performed on the game floating window in the small window mode, the game floating window in the large window mode on the client interface, and displaying the key information and the dynamically played first picture in the game floating window in the large window mode. In one example, based on an enlarge adjustment operation performed on the game floating window in the small window mode, the game floating window in the large window mode is displayed on the client interface, and the key information indicator and the video clip are displayed in the game floating window.

As a non-limiting example, after the displaying a game floating window in a large window mode on the client interface, and displaying, in the game floating window in the large window mode, the key information and a dynamically played first picture, the method further includes: displaying, in response to a shrink adjustment operation performed on the game floating window in the large window mode, the game floating window in the small window mode on the client interface, and displaying, in the game floating window in the small window mode, the key information and the first picture that remains static. The enlarge adjustment operation may be any operation triggered to enlarge the game floating window. For example, it may be a click/tap operation performed on an enlarge button of the game floating window. The shrink adjustment operation may be any operation triggered to shrink the game floating window. For example, it may be a click/tap operation performed on a shrink button of the game floating window. In one example, based on a shrink adjustment operation performed on the game floating window in the large window mode, the game floating window in the small window mode is displayed on the client interface, and the key information indicator and the static picture are displayed in the game floating window.

In some embodiments, for the switching from the small window mode to the large window mode, when a player may need to view a game situation in more detail, the player may perform the enlarge adjustment operation on the game floating window in the small window mode. In response, the game floating window in the large window mode may be displayed on the client interface. In the game floating window in the large window mode, in addition to the key information, the dynamically played first picture may be further displayed, namely the continuous animation including the plurality of frames of game pictures.

For the switching from the large window mode to the small window mode, when the player does not need the large window mode, or intends to go back to the small window mode, the player may perform the shrink adjustment operation on the game floating window in the large window mode. In response, the game floating window in the small window mode may be displayed on the client interface. In the game floating window in the small window mode, the key information and the first picture that remains static may be displayed.

For example, in some embodiments, a player is continuously detecting transaction information in an MMORPG in the small window mode. Suddenly, the player notices that a special item is being auctioned, and decides to carefully observe details of the item. The game floating window is switched to the large window mode once the player clicks/taps the enlarge button of the game floating window, and game pictures related to the item start to be dynamically played.

After viewing the details of the item carefully, the player decides to go back to the small window mode to continuously detect another transaction. The game floating window is switched back to the small window mode once the player clicks/taps the shrink button of the game floating window, and key information and a static game picture that are related to the transaction are displayed.

This embodiment allows a player to freely perform switching between the small window mode and the large window mode, thereby enhancing an interactive experience of the player. In the small window mode, the player can quickly obtain the key information without interfering with other tasks. While in the large window mode, the player can learn about the real-time situation of the game more deeply and make a more intelligent decision. Such a flexible switching mechanism enables the player to better balance a relationship between a game and another application, thereby improving overall processing efficiency of the virtual game.

In this embodiment provided by this disclosure, in response to the enlarge adjustment operation performed on the game floating window in the small window mode, the game floating window in the large window mode is displayed on the client interface, and the key information and the dynamically played first picture are displayed in the game floating window in the large window mode. In response to the shrink adjustment operation performed on the game floating window in the large window mode, the game floating window in the small window mode is displayed on the client interface, and the key information and the first picture that remains static are displayed in the game floating window in the small window mode. Thus, a purpose of enabling, by using the flexible switching mechanism, a player to better balance the relationship between the game and another application is achieved, and the technical effect of improving the overall processing efficiency of the virtual game is achieved.

As a non-limiting example, after the displaying a game floating window in a small window mode on the client interface, and displaying, in the game floating window in the small window mode, the key information and a first picture that remains static, the method further includes:
S3-1: adjust a display area or a display position of the game floating window on the client interface in a case that the client interface changes (for example, adjusting a display area or a display position of the game floating window on the client interface based on a display resource available to the game floating window on the client interface changes); and
S3-2: display, if an adjusted display area of the game floating window is larger than a preset window area, the game floating window in the large window mode on the client interface, and display the key information and the dynamically played first picture in the game floating window in the large window mode, a display area of the game floating window in the small window mode being smaller than or equal to the preset window area, and a display area of the game floating window in the large window mode being larger than the preset window area. In one example, based on an adjusted display area of the game floating window being greater than a reference window area, the game floating window in the large window mode is displayed on the client interface, and the key information indicator and the video clip are displayed in the game floating window in the large window mode.

As a non-limiting example, after the displaying a game floating window in a large window mode on the client interface, and displaying, in the game floating window in the large window mode, the key information and a dynamically played first picture, the method further includes:
S4-1: adjust a display area or a display position of the game floating window on the client interface in a case that the client interface changes (for example, adjusting a display area or a display position of the game floating window on the client interface based on a display resource available to the game floating window on the client interface changes); and
S4-2: display, if the adjusted display area of the game floating window is smaller than or equal to the preset window area, the game floating window in the small window mode on the client interface, and display, in the game floating window in the small window mode, the key information and the first picture that remains static. In one example, based on the adjusted display area of the game floating window being less than or equal to the reference window area, the game floating window in the small window mode is displayed on the client interface, and the key information indicator and the static pictures are displayed in the game floating window in the small window mode.

In some cases, a player may adjust a size or layout of the client interface while using the game floating window. To ensure that the game floating window is still valid and visible, the game floating window may need to have a particular adaptation capability.

In some embodiments, for adaptive adjustment in the small window mode, when the game floating window in the small window mode is displayed on the client interface, and the client interface changes (for example, an available space of the interface changes because of opening or closing of another application), this embodiment may adaptively adjust the display area or the display position of the floating window, to provide that the floating window is still visible and does not hinder another application. If the adjusted area of the floating window exceeds the preset window area, this embodiment may automatically switch the floating window to the large window mode and display and the dynamic first picture.

For the adaptive adjustment in the large window mode, when the game floating window in the large window mode is displayed on the client interface, and the client interface changes, this embodiment also performs the adaptive adjustment. However, if the adjusted area of the floating window is less than or equal to the preset window area, this embodiment may automatically switch the floating window back to the small window mode and display the static first picture.

For example, in some embodiments, a player is playing a game in the small window mode, and suddenly opens a video player occupying a large screen space. To ensure that the game floating window is still visible, the game floating window may be automatically shrunk and moved to an idle region of a screen. However, a new display position causes the display area of the floating window to exceed the preset window area, the floating window is automatically switched to the large window mode.

However, after watching a video, the player closes the video player. This releases a large screen space. The game floating window is automatically enlarged, and uses the additional space. However, the display area of the game floating window is smaller than the preset window area now, so that the game floating window is automatically switched back to the small window mode.

In this embodiment provided by this disclosure, the display area or the display position of the game floating window on the client interface is adaptively adjusted in a case that the client interface changes; and if the adjusted display area of the game floating window is larger than the preset window area, the game floating window in the large window mode is displayed on the client interface, and the key information and the dynamically played first picture are displayed in the game floating window in the large window mode, where the display area of the game floating window in the small window mode is smaller than or equal to the preset window area, and the display area of the game floating window in the large window mode is larger than the preset window area. The display area or the display position of the game floating window on the client interface is adaptively adjusted in a case that the client interface changes; and if the adjusted display area of the game floating window is smaller than or equal to the preset window area, the game floating window in the small window mode is displayed on the client interface, and the key information and the first picture that remains static are displayed in the game floating window in the small window mode.

As a non-limiting example, the replacing the virtual game interface displayed on the client interface with a game floating window, and displaying a second picture in the game floating window includes (not shown in the figure):
S5-1: display, if the window display request is a window request triggered for the first time on the virtual game interface, a game floating window in a default mode on the client interface, and display the second picture in the game floating window in the default mode, the default mode being the small window mode or the large window mode;
S5-2: if the window display request is not the window request triggered for the first time and the game floating window is in the small window mode at the end of the displaying of the game floating window in response to a previous triggered window request of the window display request, display the game floating window in the small window mode on the client interface, and display, in the game floating window in the small window mode, the key information and the first picture that remains static, the first picture that remains static being one of the plurality of frames of game pictures in which the virtual game is continuously played (for example, based on the window display request not being the window request triggered for the first time, and the game floating window being in the small window mode at an end of display of the game floating window based on a previous triggered window request, the game floating window in the small window mode is displayed on the client interface); and
S5-3: if the window display request is not the window request triggered for the first time and the game floating window is in the large window mode at the end of the displaying of the game floating window in response to the previous triggered window request of the window display request, display the game floating window in the large window mode on the client interface, and display the key information and the dynamically played first picture in the game floating window in the large window mode, the dynamically played first picture including the plurality of frames of game pictures (for example, based on the window display request not being the window request triggered for the first time, and the game floating window being in the large window mode at the end of the display of the game floating window based on the previous triggered window request, the game floating window in the large window mode is displayed on the client interface).

When a player triggers the window display request for the first time, this embodiment may display the game floating window in the default mode on the client interface. The default mode may be the small window mode or the large window mode, which specifically depends on a system setting or an initial selection of the player. The second picture may be displayed in the game floating window. However, when the player triggers the window display request again (not the first time), the system checks the mode (the small window mode or the large window mode) that is used when the game floating window is closed last time, and displays the game floating window in a corresponding mode in response to the information. If the game floating window is in the small window mode last time, the game floating window in the small window mode is also displayed this time, and the key information and the first picture that remains static are displayed in the game floating window. If the game floating window is in the large window mode last time, the game floating window in the large window mode is displayed this time, and the key information and the dynamically played first picture are displayed in the game floating window.

For example, in some embodiments, the player clicks/taps a “floating window” button in the virtual game for the first time. In response to the window display request triggered for the first time, the game floating window in the default mode (e.g., the small window mode) is displayed, and the second picture related to the virtual game is displayed in the game floating window. The player has opened the game floating window in the large window mode before and closed the game floating window. When the player clicks/taps the “floating window” button again, it is detected that the button is not triggered for the first time and the large window mode is closed last time. Therefore, this embodiment displays the game floating window in the large window mode again and displays the key information and the dynamic first picture in the game floating window.

In this embodiment provided by this disclosure, if the window display request is the window request triggered for the first time on the virtual game interface, the game floating window in the default mode is displayed on the client interface, and the second picture is displayed in the game floating window in the default mode, where the default mode is the small window mode or the large window mode. If the window display request is not the window request triggered for the first time and the game floating window is in the small window mode at the end of the displaying of the game floating window in response to a previous triggered window request of the window display request, the game floating window in the small window mode is displayed on the client interface, and the key information and the first picture that remains static are displayed in the game floating window in the small window mode, where the first picture that remains static is one of the plurality of frames of game pictures in which the virtual game is continuously played. If the window display request is not the window request triggered for the first time and the game floating window is in the large window mode at the end of the displaying of the game floating window in response to the previous triggered window request of the window display request, the game floating window in the large window mode is displayed on the client interface, and the key information and the dynamically played first picture are displayed in the game floating window in the large window mode, where the dynamically played first picture includes the plurality of frames of game pictures. Thus, a purpose of intelligently memorizing a last state (the small window mode or the large window mode) of the game floating window and restoring this state at next opening is achieved, and a technical effect of improving game floating window operation efficiency is achieved.

As a non-limiting example, in the process of replacing, in response to a window display request triggered on the virtual game interface, the virtual game interface displayed on the client interface with a game floating window, and displaying a second picture in the game floating window, the method further includes:
displaying event prompt information in the game floating window in a case that an important game event occurs in the virtual game, the event prompt information being configured for prompting occurrence of the important game event. In one example, event prompt information is displayed in the game floating window based on a game event occurring in the virtual game, where the event prompt information indicates occurrence of the game event.

In some embodiments, the important game event may be, but is not limited to, an event that happens in the game process and has a large impact on a game experience of a player or has a particular significance. These events are usually related to a plot, tasks, character interactions, or other core game mechanisms of a game. For example, in some plot-driven virtual games, a particular plot event or a decision-making point may be considered as an important game event. For example, when a player reaches a key plot turning point and may need to make a selection affecting the direction of the story, the decision-making point is considered as an important event. Or, in most virtual games, a main task or a main challenge constitutes core content of each game. When a main task starts, is updated, or is completed, the start, the update, or the completion may be considered as important game events. Or, in some virtual games, a player has a chance to obtain a special reward, achievement, or honor. When such a chance occurs, or the player successfully unlocks a special reward, these may be considered as important events.

When the player uses the game floating window, if an important game event (such as a key task, a special reward, or another important update) occurs in the virtual game, this embodiment may display the event prompt information in the floating window, to provide that the player does not miss the important information or chance.

For example, in some embodiments, it is assumed that a player is playing an MMORPG and continuously detects the virtual game by using the game floating window. Suddenly, a time-limited task occurs in the virtual game, which requires the player to complete the task within short time to obtain a special reward. To facilitate that the player can notice the task, this embodiment displays the event prompt information, such as flashing red text or a special icon, in the game floating window to prompt the player that the task occurs.

In this embodiment provided by this disclosure, in a case that the important game event occurs in the virtual game, the event prompt information is displayed in the game floating window, where the event prompt information is configured for prompting the occurrence of the important game event. Thus, when another task is performed in a floating window mode, the player can obtain the information of the important event in the game in time, thereby achieving a technical effect of improving timeliness of the important game event.

As a non-limiting example, in the process of displaying the event prompt information in the game floating window, the method further includes: displaying a to-be-viewed label in the game floating window, the to-be-viewed label being configured for prompting that the important game event is in a to-be-viewed state; and
displaying the virtual game interface on the client interface in response to a display restoration request triggered on the game floating window, and displaying, on the virtual game interface, a game picture in which the important game event occurs, the important game event being set to be in a viewed state.

In this embodiment, by introducing the functions of the to-be-viewed label and the display restoration request, a game experience of a player is further enhanced, and the player may keep paying attention to an important event in the virtual game while using the game floating window. The instantaneity and the convenience improve satisfaction of the player and overall attractiveness of the game. In addition, the important game event is set to be in the viewed state. This avoids unnecessary repeated prompts, and makes the game experience of the player smoother and more efficient.

For example, in some embodiments, it is assumed that a player is browsing another application by using the game floating window, and an enemy intrusion event that may need to be processed urgently occurs in the virtual game. In this embodiment, a flashing “to-be-viewed” label is displayed in the game floating window. The player notices the label and clicks/taps it, thus triggering a display restoration request. In response to the request, this embodiment displays the virtual game interface in full screen, directly locates an enemy intrusion site, and displays battle-related pictures. After the player successfully defends against the intrusion of the enemy, the event is set to be in the viewed state, and the to-be-viewed label in the game floating window disappears.

In this embodiment provided in this disclosure, the to-be-viewed label is displayed in the game floating window, where the to-be-viewed label is configured for prompting that the important game event is in the to-be-viewed state; and the virtual game interface is displayed on the client interface in response to the display restoration request triggered on the game floating window, and the game picture in which the important game event occurs is displayed on the virtual game interface, where the important game event being set to be in the viewed state. Thus, a purpose of keeping paying attention to an important event in the virtual game while using the game floating window is achieved, and a technical effect of improving display validity of the game floating window is achieved.

As a non-limiting example, before the replacing, in response to a window display request triggered on the virtual game interface, the virtual game interface displayed on the client interface with a game floating window, and displaying a second picture in the game floating window, the method further includes (not shown in the figure):
S6-1: display a window setting interface on the virtual game interface, the window setting interface being configured for setting a display function of the game floating window; and
S6-2: setting, in response to a function enabling request triggered on the window setting interface, the display function of the game floating window to be in an enabled state, the window display request being allowed to be triggered on the virtual game interface set to be in the enabled state.

In this embodiment, by introducing the window setting interface and the function enabling request mechanism, flexibility and adaptability of the virtual game are significantly improved. A player may adjust display settings of the game floating window based on a need of the player and a scene, to obtain a best game experience in different scenes. This personalized setting option enriches interaction manners of the game, satisfies unique requirements of different players, and further improves attractiveness of the game and user satisfaction.

For example, in some embodiments, it is assumed that a player enters, for the first time, a virtual game that supports a game floating window function. Before the virtual game starts, a window setting interface is displayed, to allow the player to select settings such as a size, transparency, and a position of a game floating window. After completing the settings based on a preference of the player, the player clicks/taps an “enable” button to trigger a function enabling request. Further, in response to the request, a display function of the game floating window is set to be in an enabled state. Therefore, when the player triggers the window display request in the virtual game (for example, by clicking/tapping a specific user interface (UI) element), a customized game floating window may be displayed on the client interface, and the customized game floating window includes a second picture that the player intends to view.

In this embodiment provided by this disclosure, the window setting interface is displayed on the virtual game interface, where the window setting interface is configured for setting a display function of the game floating window; and in response to a function enabling request triggered on the window setting interface, the display function of the game floating window is set to be in the enabled state, where the window display request is allowed to be triggered on the virtual game interface set to be in the enabled state. Thus, a purpose of enriching interaction manners of the game and satisfying unique requirements of different players is achieved, and a technical effect of improving interaction flexibility of the game is achieved.

As a non-limiting example, after the setting, in response to a function enabling request triggered on the window setting interface, the display function of the game floating window to be in an enabled state, the method further includes (not shown in the figure):
S7-1: trigger the window display request if an interface exit operation performed on the virtual game interface is obtained; or
S7-2: trigger the window display request if an interface jump operation performed on another application interface is obtained.

In this embodiment, the window display request is automatically triggered, so that a game experience of a player is further optimized. The game floating window can provide continuous information and a function support no matter whether the player is in the virtual game or performs switching between the virtual game and another application. This seamless integrated and efficient interaction manner improves satisfaction of the player and overall attractiveness of the game. In addition, this also improves interconnectivity between the game and another application, and a smoother and more convenient multitasking environment is created for the player.

For example, in some embodiments, it is assumed that a player is viewing a map or character information by using the game floating window in the game, and then the player decides to temporarily exit the virtual game interface to view social media. In a case that the interface exit operation is performed or a social media application interface is jumped to, this embodiment automatically triggers the window display request. Therefore, even if the player is currently in a social media application, the game floating window still remains visible, thus providing convenient information or function access.

In this embodiment provided by this disclosure, the window display request is triggered if the interface exit operation performed on the virtual game interface is obtained; or the window display request is triggered if the interface jump operation performed on another application interface is obtained. Thus, a purpose of creating a smoother and more convenient multitasking environment for the player is achieved, and a technical effect of improving game floating window operation efficiency is achieved.

As a non-limiting example, before the replacing, in response to a window display request triggered on the virtual game interface, the virtual game interface displayed on the client interface with a game floating window, and displaying a second picture in the game floating window, the method further includes: in the process of displaying the virtual game interface on the client interface and displaying the first picture on the virtual game interface, displaying, on the virtual game interface if an idle game event occurs in the virtual game, a virtual waiting control associated with the idle game event, the idle game event being a game event that is allowed to be detached from an active operation in the virtual game; and triggering the window display request in response to a selection operation performed on the virtual waiting control. In one example, a virtual waiting control associated with an idle game event is displayed on the virtual game interface based on the idle game event occurring in the virtual game. The idle game event corresponds to a game event that is allowed to be detached from an active operation in the virtual game. In one example, the window display request is triggered based on a selection operation performed on the virtual waiting control.

In this embodiment, by introducing the virtual waiting control and the mechanism for triggering the window display request, interactivity and convenience of the game are significantly enhanced. A player may easily perform switching between the idle game event and another task without worrying about missing any important information or chance. This seamless integrated and efficient interaction manner improves satisfaction of the player and overall attractiveness of the game. Meanwhile, this also makes the game more adaptable to a multitasking requirement and life rhythm of a modern player, and creates a more flexible and convenient game experience environment for the player.

For example, in some embodiments, it is assumed that a player sets an idle task of automatic fishing for a character in the game. When the task starts, this embodiment displays a virtual waiting control associated with the task on the virtual game interface, such as a progress bar representing a fishing progress. The player may click/tap the progress bar at any time to view more information about the fishing (such as fish that has been caught and a fishing place). When the player clicks/taps the progress bar, this embodiment automatically triggers a window display request, and a game floating window is displayed on a screen. The game floating window includes detailed information related to the fishing event.

In this embodiment provided by this disclosure, in a case that the idle game event occurs in the virtual game, the virtual waiting control associated with the idle game event is displayed in the virtual game interface, where the idle game event is the game event that is allowed to be detached from the active operation in the virtual game; and the window display request is triggered in response to the selection operation performed on the virtual waiting control. Thus, a technical effect of improving display validity of the idle game event is achieved.

As a non-limiting example, the replacing, in response to a window display request triggered on the virtual game interface, the virtual game interface displayed on the client interface with a game floating window, and displaying a second picture in the game floating window includes (not shown in the figure):
S8-1: replace, in response to the window display request triggered on the virtual game interface, the virtual game interface displayed on the client interface with the game floating window, and display the first picture and key information of the idle game event in the game floating window. In one example, the key information indicator includes key information of the idle game event.

After the replacing, in response to a window display request triggered on the virtual game interface, the virtual game interface displayed on the client interface with a game floating window, and displaying a second picture in the game floating window, the method further includes:
S8-2: restore the displaying of the virtual game interface on the client interface when the idle game event ends.

In this embodiment, by simultaneously displaying the first picture and the key information of the idle game event in the game floating window, a player may learn about a current state of the game and a progress of the idle task more intuitively. Due to the instantaneity and the transparency, satisfaction of the player and overall attractiveness of the game are improved. Meanwhile, the mechanism of automatically restoring the displaying of the virtual game interface when the idle game event ends facilitates continuity and smoothness of the game, and reduces a cognitive burden and time costs of the player during operation switching. This efficient and convenient processing manner enhances a playability and user experience of the game, so that the player can enjoy the fun of the game more happily.

For example, in some embodiments, it is assumed that a player sets an idle task in which a character automatically acquires a resource, and the idle task is associated with a virtual waiting control. When the player clicks/taps the control, this embodiment triggers a window display request, and displays a game floating window on the client interface. In the game floating window, the player may see a scene (the first picture) in which the character is acquiring a resource, and a quantity and type (the key information) of the acquired resource. After the acquisition task is completed, this embodiment automatically hides the floating window, and restores the displaying of the virtual game interface, to allow the player to continue to perform another game task.

In this embodiment provided by this disclosure, the game floating window is displayed on the client interface, and the first picture and the key information of the idle game event are displayed in the game floating window. The displaying of the virtual game interface is restored on the client interface when the idle game event ends. Thus, a technical effect of improving execution efficiency of the idle game event while ensuring display validity of the idle game event

As a non-limiting example, after the displaying a virtual game interface on a client interface and displaying a first picture on the virtual game interface, the method further includes (not shown in the figure):
S9-1: display window prompt information in response to a preliminary window request triggered on the virtual game interface, the window prompt information being configured for prompting to prepare to display the game floating window (for example, the window prompt information indicates preparation of replacing the virtual game interface); and
S9-2: display the game floating window on the client interface in response to a secondary window request triggered on the window prompt information; or display a background application interface on the client interface in response to a third window request triggered on the window prompt information, at least one application that is run in a background being displayed on the background application interface, and the at least one application including an application of the virtual game.

In this embodiment, by gradually responding to the window request and displaying the corresponding prompt information, the game floating window, and the background application interface, an interactive experience of a player is significantly enhanced. This embodiment provides that the player can quickly perform switching between different tasks and applications without exiting the game or interrupting a current activity. This not only improves attractiveness and playability of the game, but also enables the player to manage time and tasks more efficiently. Meanwhile, by displaying the background application interface, the player can easily perform switching between different applications, thereby keeping control and management on a plurality of tasks. Due to the flexibility and the convenience, the user experience and attractiveness of the game are further enhanced.

For example, in some embodiments, it is assumed that a player is playing the game, and intends to temporarily view some other information or applications. The player first triggers the preliminary window request (for example, clicks/taps a specific UI element) on the virtual game interface. In this embodiment, in response to the request, one piece of window prompt information is displayed, to notify the player that the player can view a game floating window. If the player clicks/taps the window prompt information, the secondary window request is triggered, and this embodiment may display the game floating window which includes some additional game information or functions. If the player intends to view another application run in the background, the player may trigger the third window request by touching and holding the prompt information. As a response, the system may display the background application interface, and list all applications run in the background, including the virtual game that is being played by the player.

In this embodiment provided by this disclosure, the window prompt information is displayed in response to the preliminary window request triggered on the virtual game interface, where the window prompt information is configured for prompting to prepare to display the game floating window; and the game floating window is displayed on the client interface in response to the secondary window request triggered on the window prompt information; or the background application interface is displayed on the client interface in response to the third window request triggered on the window prompt information, where at least one application that is run in a background is displayed on the background application interface, and the at least one application includes the application of the virtual game. Thus, a purpose of providing an intuitive and efficient manner to access and control a plurality of application interfaces is achieved, and a technical effect of improving multitasking efficiency is achieved.

As a non-limiting example, after the displaying, in response to a window display request triggered on the virtual game interface, the game floating window on the client interface, and displaying a second picture in the game floating window, the method further includes:
prompting key information of a key node by voice in a case that the key node is triggered in the game process of the virtual game. In one example, a voice notification indicating key information of a key node of the virtual game is played based on the key node is triggered according to a game process of the virtual game.

In some embodiments, the key node in the virtual game refers to an event, a scene, or a moment that has special importance, significantly affects the game process, or involves a key decision. For example, the key node may appear in a plot of the virtual game, and serve as a turning point of the plot. These nodes are usually moments at which the plot has climax, important characters interact with each other, or important information is disclosed. Decisions and actions of the player at these nodes may have significant impact on the development of the story, and even change a direction and end of the virtual game.

However, in the virtual game, the player may need to complete a series of tasks to push the game process. Some tasks may have higher importance and urgency, and constitute key nodes. These tasks may involve key fighting, depuzzling, exploration, or other challenges, and are of significance in the overall progress of the virtual game and the character development of the player. In some cases, the player may need to make important decisions in the virtual game, and these decisions may significantly affect the progress and result of the virtual game. These decision points constitute the key nodes, and the player is required to consider various options carefully and make a wise choice.

In this embodiment, by prompting the key information by voice when the key node is triggered in the game process of the virtual game, the game experience of the player is significantly enhanced. Such an instant voice prompt provides that the player can learn about the important information related to the game process in time, to make a wiser and more effective decision. This not only improves the playability and attractiveness of the game, but also reduces a possibility that the player makes a mistake at a key moment due to lack of information. Meanwhile, the voice prompt also provides a more intuitive and immersive interaction manner for the player, so that the player can sense the atmosphere and scene of the game more deeply. Due to the comprehensive improvement, the user experience and satisfaction of the game are further enhanced.

For example, in some embodiments, it is assumed that a player is playing a role playing game, and triggers the key node at a key moment (for example, a dialog with an important non-player character (NPC) or an imminent battle). When the second picture is displayed in the floating window, this embodiment prompts the player by voice “Warning! Battle again the evil wizard is about to begin! Please ensure that you have the required equipment and skills ready.” This voice prompt provides important information about an imminent challenge for the player, so that the player can make corresponding preparations.

In this embodiment provided by this disclosure, in a case that the key node is triggered in the game process of the virtual game, the key information of the key node is prompted by voice. Thus, a purpose of reducing the possibility that the player makes a mistake at the key moment due to lack of information is achieved, and a technical effect of improving timeliness of prompting of the key node is achieved.

As a non-limiting example, for ease of understanding, the above game picture display method is applied to an auto battler game. When a player uses a mobile device to play the auto battler game, there are problems that a multiplayer arena stage is complex and waiting time is long. The player may need to pay high attention to level content and countdown, and is also annoyed due to the waiting time which is several seconds or twenty seconds in each stage. This embodiment provides a small window manner based on a mobile phone, to adapt to functional content based on different window sizes. In a large mode, a game can be properly played. In a small mode, a player is reminded of important events and countdown points. A better experience that a player plays a game while opening and operating other applications (APP) is provided.

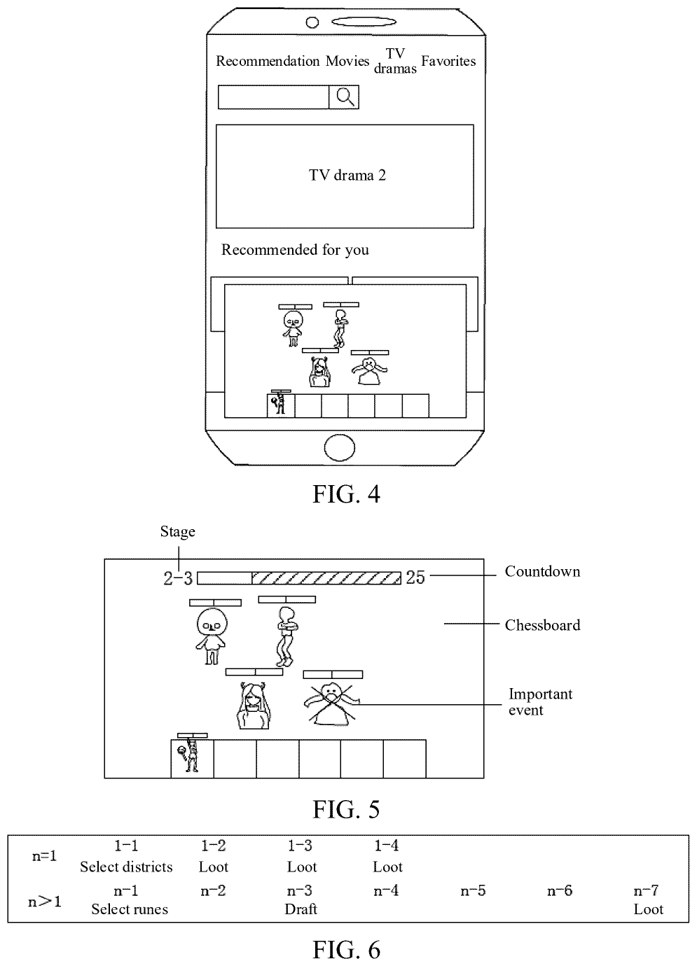

In some embodiments, as shown in FIG. 4, when an auto battler game is displayed in a small window manner (i.e. a game floating window), a game interface can only be entirely placed on a small window interface. However, after being shrunk, the complex virtual game interface with fine controls of the auto battler game cannot be operated and/or seen properly, and detailed stages and events of the auto battler game cannot be prompted in a targeted manner. A player may miss various important selection nodes in a small window, thereby causing a decisive negative impact on the virtual game. If the player frequently switches to the background of the mobile phone, the performance of most hardware may cause fatal problems such as background application killing and restart of applications. This seriously affects a game rhythm.

In some embodiments, the auto battler game is used as an example. As shown in FIG. 5, information strongly correlated to game stages and events, such as countdown, stages, and important event pop-up windows, is prompted in a small window.

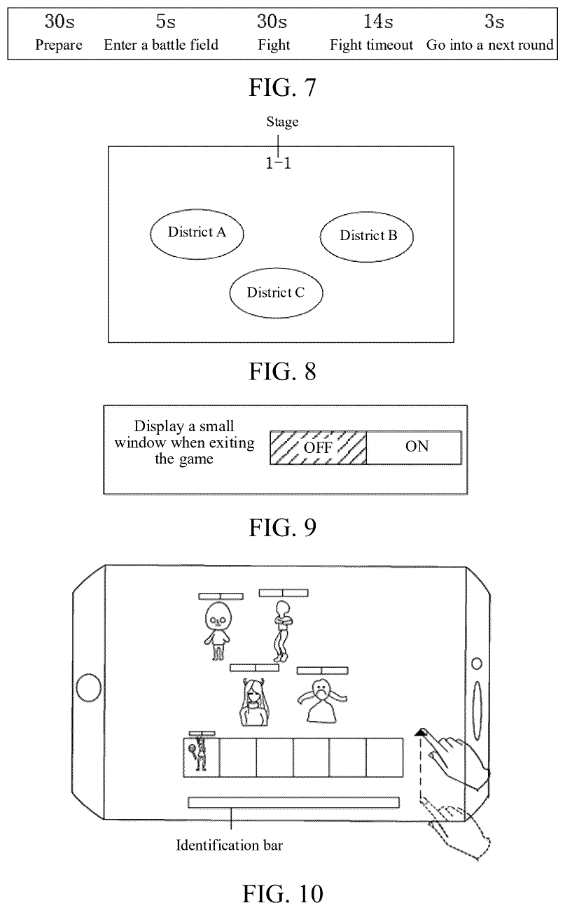

Specifically, as shown in FIG. 6, the auto battler game has a total of eight stages, and each stage has a total of seven rounds, where n represents a stage. The same event occurs in each round. As shown in FIG. 7, except a selection round, cycle time is fixed for each round, and each round has a corresponding function. As shown in FIG. 8, districts of a current round are selected based on round 1-1, and each district may correspond to different important events.

In some embodiments, as shown in FIG. 9, a player may activate a switch button of “display a small window when exiting the game” in the settings of the auto battler game. As shown in FIG. 10, the game interface is slid up to enter another APP or return to a mobile phone desktop. For example, an identification bar appears when the game interface is slid up for the first time. The mobile phone desktop is displayed when the game interface is slid up for the second time on a large scale, and a screen-split background interface is displayed when the game interface is slid up on a small scale. Another APP may be selected from the screen-split background interface to enter.

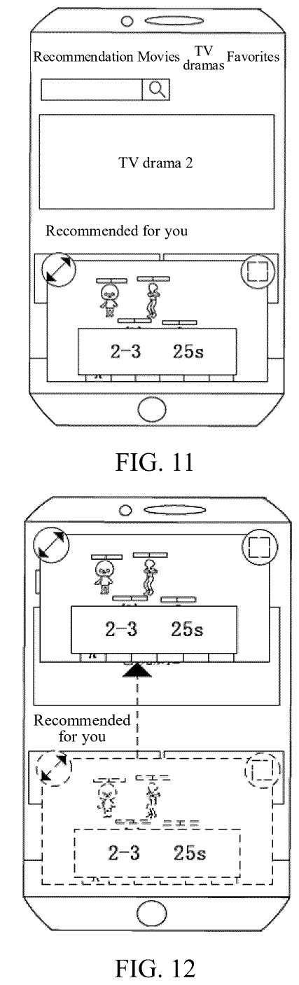

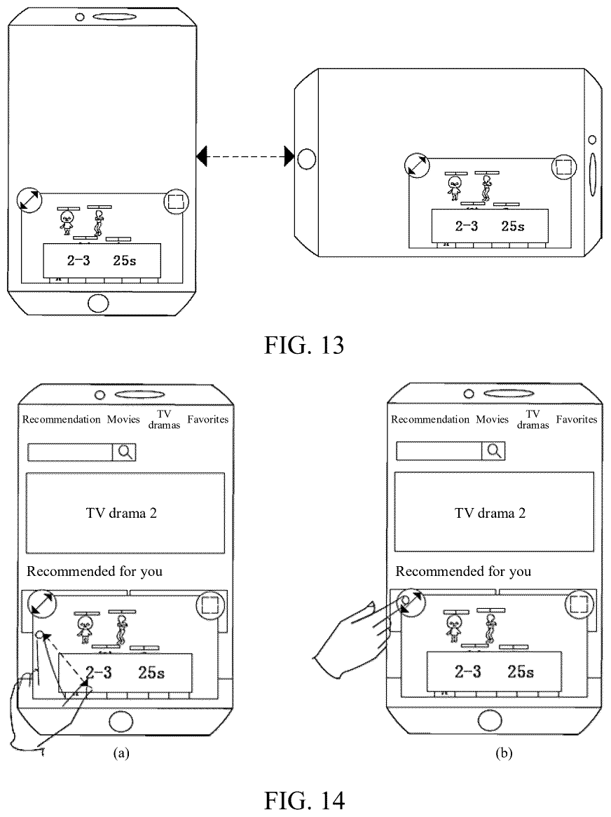

In some embodiments, a small window interface, i.e. a game floating window, appears. The small window interface is in a size of the small window last time by default. If no small window has ever appeared, the small window interface is in a maximum size by default. If the small window has a large size at this time, a real-time game effect is synchronized, only the resolution is reduced, and two pieces of key information such as round-stage and countdown are enlarged. As shown in FIG. 11, “2-3” is stage-round, and “25 s” is countdown. As shown in FIG. 12, a display position of the small window may be moved. For example, the small window is moved from a place below the client interface to a place above the client interface in FIG. 12. Further, as shown in FIG. 13, the small window may be directionally adaptive based on a landscape mode/a portrait screen mode.

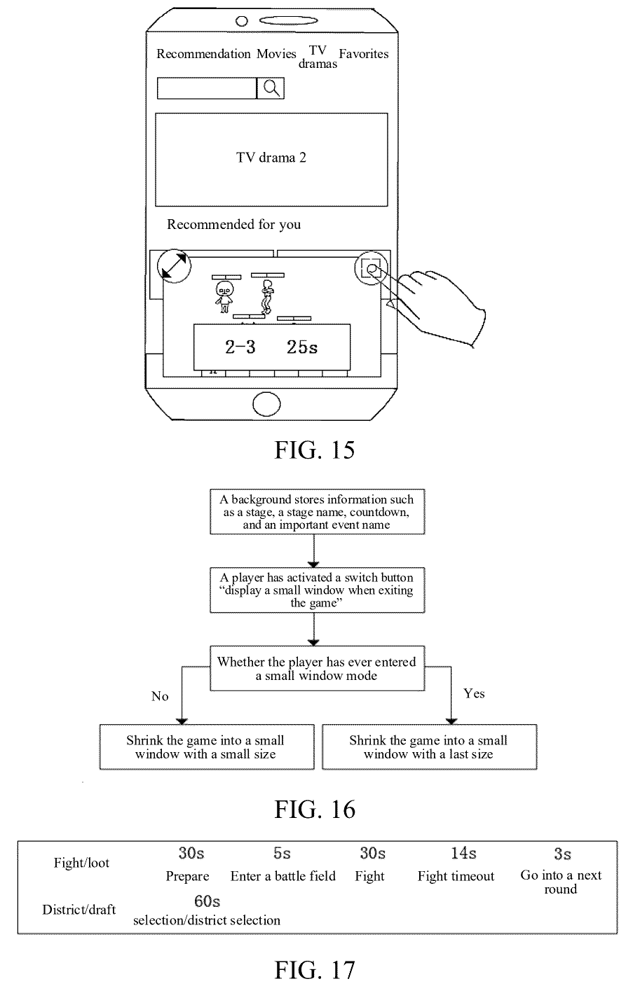

In some embodiments, as shown in FIG. 14(a), the small window may be zoomed with two fingers, to adjust the size of the window. A zoom button may be pressed, as shown in FIG. 14(b), to adjust the size of the window. When the small window has a small size, this frame of interface of a real-time effect of the game is captured, keeps still, and is automatically covered with a black mask. A stage, a stage name, countdown, important event information, and a stage view state are displayed and may change as game rounds change. As shown in FIG. 15, an expansion button is tapped, the small window is closed, and the game is opened to the foreground.

In some embodiments, for how to enter the small window mode, as shown in FIG. 16, the background stores a plurality of pieces of information such as a stage, a stage name, countdown, and an important event name based on a game rule; whether a player activates the switch button of “display a small window when exiting the game” is detected. When the player slides on the bottom of the interface, whether the player exits the foreground of the game is detected based on a detection condition of each mobile phone software system. If the player exits the foreground of the game, detects whether the player has ever entered the small window mode of the game. If the player has not entered the small window mode of the game, shrink the game into a small window with a large size. If the player has entered the small window mode of the game, shrink the game to a small window with the last size.

In some embodiments, the real-time effect of the game is synchronized, which is presented only with a reduced resolution. In addition, the two pieces of information, i.e. the stage and the countdown, are enlarged and change as the game rounds change. The following stage is presented as “round-stage”. The countdown of each stage is switched in coordination with the UI and rule of the original game, including time shown in FIG. 17.

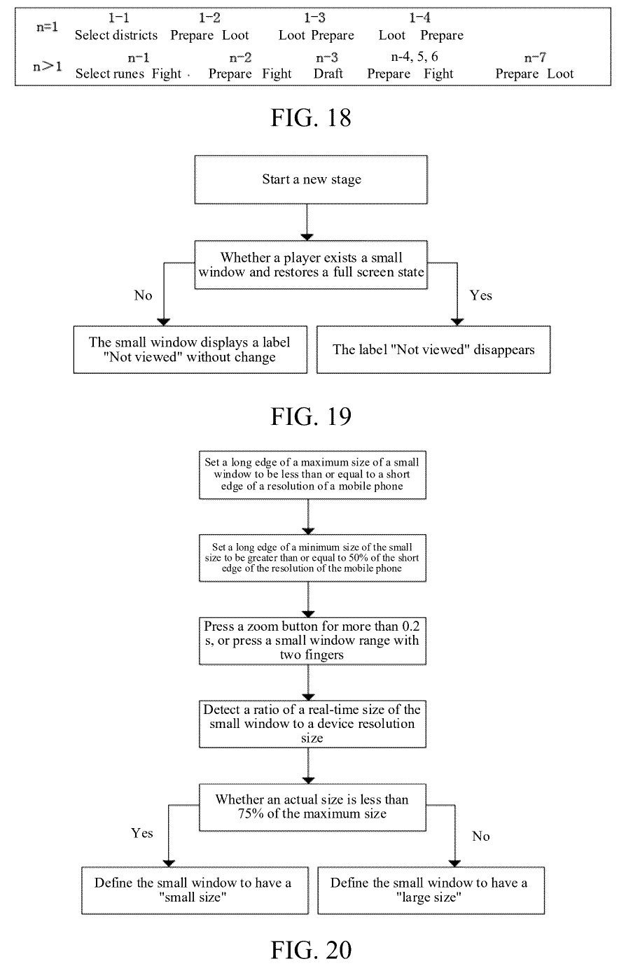

In some embodiments, this frame of interface of a real-time effect of the game is captured, keeps still (no more real-time rebroadcasting), and is automatically covered with a black mask; a stage, a stage name, countdown, important event information, and a stage view state are displayed, and change as the game rounds change. A display rule for the round, the stage, and the countdown is the same as the display rule in a large size, and will not be repeated. The stage name rule is shown in FIG. 18. The switching time is synchronized with the time in the game. The important event can be configured with different event names based on the game rule (the important event and the stage name may possibly appear simultaneously).

For example, selectable stage states are shown in FIG. 19. Whether a new stage starts is detected. If yes, whether a player has exited the small window to restore a full screen state is detected. If no, the small window displays a label “Not viewed” without change. If yes, the label “Not viewed” disappears.

In some embodiments, for an operation on the small window, whether the direction of the mobile phone rotates is determined, and if yes, the small window changes with a rotation direction and an angle of a screen. When a finger of a player presses and drags the small window within the small window range, the small window moves within a boundary of the screen with the finger of the player.

In some embodiments, zooming (size switching) is shown in FIG. 20. A zoom button is pressed, and whether the pressing lasts for more than 0.2 s is detected; if yes, it is considered that the zoom button is triggered, and dragging may implement zooming on an equal scale and adjust the size of the small window. The size of the small window is detected in real time. If the real-time size is less than 75% of a maximum size, the small window is in a “small size”; and otherwise, the small window is in a “large size”. A long edge of the maximum size is less than or equal to a short edge of the resolution of the mobile phone, and a long edge of the minimum size is greater than or equal to 50% of the resolution of the mobile phone.

In some embodiments, the expansion button is tapped; the small window is closed; the game is opened to the foreground; and the small window mode is exited.

In this embodiment provided by this disclosure, this embodiment provides a manner in which the player may view an important node, a node state, and countdown in the auto battler game through the small window when the player exits the game to the background. This manner has the following beneficial effects: The auto battler, as a multiplayer strategy game, has a plurality of key time nodes and corresponding content. When the player completes decision making by self and waits when another player adjusts chessboard-related strategies, the player has nothing to do and is usually annoyed. This is a long-standing problem. However, there is another problem that after the player is out of patience and exits the game the player, the player finds that a time node is missed, the network is lagged, the background is refreshed, and the like. This embodiment provides free and reassuring options for the player and enhances the user experience. In this embodiment, each stage has been briefly introduced, and important information has been extracted and prompted, thus avoiding the player from missing the important information in the small window stage. Since controls are very small, the player cannot operate the controls. This embodiment cancels these operations, but prompts the important information. This avoids a possibility of misoperations of the player.

For simple descriptions, the foregoing method embodiments are stated as a series of action combinations. However, a person skilled in the art knows that this disclosure is not limited to the sequence of the described actions because according to this disclosure, some operations may use another sequence or may be simultaneously performed. In addition, those skilled in the art are also aware that the embodiments described in this specification are non-limiting examples, and the actions and modules involved may not be necessary for this disclosure.

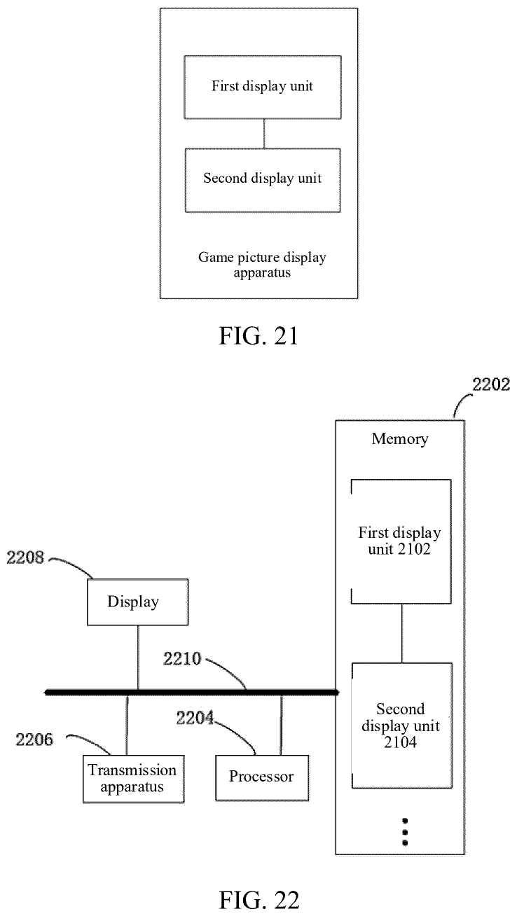

According to another aspect of the embodiments of this disclosure, a game picture display apparatus for implementing the above game picture display method is further provided. As shown in FIG. 21, the apparatus includes:
a first display unit 2102, configured to: display a virtual game interface on a client interface, and display a first picture on the virtual game interface, the virtual game interface being a display interface of a virtual game, and the first picture being a game picture of the virtual game; and
a second display unit 2104, configured to: replace, in response to a window display request triggered on the virtual game interface, the virtual game interface displayed on the client interface with a game floating window, and display a second picture in the game floating window, a display area of the game floating window being smaller than a display area of the virtual game interface, the second picture including the first picture and key information of the virtual game, and the key information being configured for prompting a game process of the virtual game.

For specific embodiments, refer to the examples shown in the above game picture display method. Details will not be elaborated here in this example.

As a non-limiting example, the second display unit 2104 includes:
a first display module, configured to display the first picture and process prompt information in the game floating window, the process prompt information being configured for prompting a running condition of at least one sub-process in the virtual game, and the key information including the process prompt information.

For specific embodiments, refer to the examples shown in the above game picture display method. Details will not be elaborated here in this example.

As a non-limiting example, the first display module includes:
a first display submodule, configured to display the first picture and first process information in the game floating window, the first process information being configured for prompting a stage and round to which a currently run sub-process of the virtual game belongs, and the process prompt information including the first process information; or
a second display submodule, configured to display the first picture and first time information in the game floating window, the first time information being configured for prompting remaining process time before the currently run sub-process of the virtual game ends; or
a third display submodule, configured to display the first picture, second process information, and second time information in the game floating window, the second process information being configured for prompting a stage and round to which the currently run sub-process of the virtual game belongs, and the second time information being configured for prompting a remaining stage time before the stage ends, or a remaining round time before the round ends; or
a fourth display submodule, configured to display the first picture, third process information, and third time information in the game floating window, the third process information being configured for prompting that the currently run sub-process of the virtual game belongs to a specified game event, and the third time information being configured for prompting remaining event time before the specified game event ends.

For specific embodiments, refer to the examples shown in the above game picture display method. Details will not be elaborated here in this example.

As a non-limiting example, the second display unit 2104 includes:
a second display module, configured to: display a game floating window in a small window mode on the client interface, and display, in the game floating window in the small window mode, the key information and a first picture that remains static, the first picture that remains static being one of a plurality of frames of game pictures in which the virtual game is continuously played; or
a third display module, configured to: display a game floating window in a large window mode on the client interface, and display the key information and a dynamically played first picture in the game floating window in the large window mode, the dynamically played first picture including the plurality of frames of game pictures.

For specific embodiments, refer to the examples shown in the above game picture display method. Details will not be elaborated here in this example.

As a non-limiting example, the apparatus further includes: a fourth display module, configured to: after displaying the game floating window in the small window mode on the client interface, and displaying, in the game floating window in the small window mode, the key information and the first picture that remains static, display, in response to an enlarge adjustment operation performed on the game floating window in the small window mode, the game floating window in the large window mode on the client interface, and display the key information and the dynamically played first picture in the game floating window in the large window mode.

Or, the apparatus further includes: a fifth display module, configured to: after displaying the game floating window in the large window mode on the client interface, and displaying the key information and the dynamically played first picture in the game floating window in the large window mode, display, in response to a shrink adjustment operation performed on the game floating window in the large window mode, the game floating window in the small window mode on the client interface, and display, in the game floating window in the small window mode, the key information and the first picture that remains static.

For specific embodiments, refer to the examples shown in the above game picture display method. Details will not be elaborated here in this example.

As a non-limiting example, the apparatus further includes:
a first adjustment module, configured to: after displaying the game floating window in the small window mode on the client interface, and displaying, in the game floating window in the small window mode, the key information and the first picture that remains static, adjust a display area or a display position of the game floating window on the client interface in a case that the client interface changes; and
a sixth display module, configured to: display, if an adjusted display area of the game floating window is larger than a preset window area, the game floating window in the large window mode on the client interface, and display the key information and the dynamically played first picture in the game floating window in the large window mode, a display area of the game floating window in the small window mode being smaller than or equal to the preset window area, and a display area of the game floating window in the large window mode being larger than the preset window area.

The apparatus further includes:
a second adjustment module, configured to: after displaying the game floating window in the large window mode on the client interface, and displaying the key information and the dynamically played first picture in the game floating window in the large window mode, adjust a display area or a display position of the game floating window on the client interface in a case that the client interface changes; and
a seventh display module, configured to: display, if the adjusted display area of the game floating window is smaller than or equal to the preset window area, the game floating window in the small window mode on the client interface, and display, in the game floating window in the small window mode, the key information and the first picture that remains static.

For specific embodiments, refer to the examples shown in the above game picture display method. Details will not be elaborated here in this example.

As a non-limiting example, the second display unit 2104 includes:
an eighth display module, configured to: display, if the window display request is a window request triggered for the first time on the virtual game interface, a game floating window in a default mode on the client interface, and display the second picture in the game floating window in the default mode, the default mode being the small window mode or the large window mode;
a ninth display module, configured to: if the window display request is not the window request triggered for the first time and the game floating window is in the small window mode at the end of the displaying of the game floating window in response to a previous triggered window request of the window display request, display the game floating window in the small window mode on the client interface, and display, in the game floating window in the small window mode, the key information and the first picture that remains static, the first picture that remains static being one of the plurality of frames of game pictures in which the virtual game is continuously played; and
a tenth display module, configured to: if the window display request is not the window request triggered for the first time and the game floating window is in the large window mode at the end of the displaying of the game floating window in response to the previous triggered window request of the window display request, display the game floating window in the large window mode on the client interface, and display the key information and the dynamically played first picture in the game floating window in the large window mode, the dynamically played first picture including the plurality of frames of game pictures.

For specific embodiments, refer to the examples shown in the above game picture display method. Details will not be elaborated here in this example.

As a non-limiting example, the apparatus further includes:
a third display unit, configured to: in the process of replacing, in response to the window display request triggered on the virtual game interface, the virtual game interface displayed on the client interface with the game floating window, and displaying the second picture in the game floating window, display event prompt information in the game floating window in a case that an important game event occurs in the virtual game, the event prompt information being configured for prompting occurrence of the important game event.

For specific embodiments, refer to the examples shown in the above game picture display method. Details will not be elaborated here in this example.

As a non-limiting example, the apparatus further includes: a fourth display unit, configured to: in the process of displaying the event prompt information in the game floating window, display a to-be-viewed label in the game floating window, the to-be-viewed label being configured for prompting that the important game event is in a to-be-viewed state.

The apparatus further includes:
a fifth display unit, configured to: display the virtual game interface on the client interface in response to a display restoration request triggered on the game floating window, and display, on the virtual game interface, a game picture in which the important game event occurs, the important game event being set to be in a viewed state.

For specific embodiments, refer to the examples shown in the above game picture display method. Details will not be elaborated here in this example.

As a non-limiting example, the apparatus further includes:
a sixth display unit, configured to: before replacing, in response to the window display request triggered on the virtual game interface, the virtual game interface displayed on the client interface with the game floating window, and displaying the second picture in the game floating window, display a window setting interface on the virtual game interface, the window setting interface being configured for setting a display function of the game floating window; and
a setting unit, configured to: before displaying, in response to the window display request triggered on the virtual game interface, the game floating window on the client interface, and displaying the second picture in the game floating window, set, in response to a function enabling request triggered on the window setting interface, the display function of the game floating window to be in an enabled state, the window display request being allowed to be triggered on the virtual game interface set to be in the enabled state.

For specific embodiments, refer to the examples shown in the above game picture display method. Details will not be elaborated here in this example.

As a non-limiting example, the apparatus further includes:
a first trigger unit, configured to: after setting, in response to the function enabling request triggered on the window setting interface, the display function of the game floating window to be in the enabled state, trigger the window display request if an interface exit operation performed on the virtual game interface is obtained; or
a second trigger unit, configured to: after setting, in response to the function enabling request triggered on the window setting interface, the display function of the game floating window to be in the enabled state, trigger the window display request if an interface jump operation performed on another application interface is obtained.

For specific embodiments, refer to the examples shown in the above game picture display method. Details will not be elaborated here in this example.

As a non-limiting example, the apparatus further includes: a seventh display unit, configured to: before replacing, in response to the window display request triggered on the virtual game interface, the virtual game interface displayed on the client interface with the game floating window, and displaying the second picture in the game floating window, in the process of displaying the virtual game interface on the client interface and displaying the first picture on the virtual game interface, display, on the virtual game interface if an idle game event occurs in the virtual game, a virtual waiting control associated with the idle game event, the idle game event being a game event that is allowed to be detached from an active operation in the virtual game.

The apparatus further includes: a third trigger unit, configured to trigger the window display request in response to a selection operation performed on the virtual waiting control.

For specific embodiments, refer to the examples shown in the above game picture display method. Details will not be elaborated here in this example.

As a non-limiting example, the apparatus further includes:
an eighth display unit, configured to: replacing, in response to the window display request triggered on the virtual game interface, the virtual game interface displayed on the client interface with the game floating window, and display the first picture and key information of the idle game event in the game floating window; and
a ninth display unit, configured to: after the replacing, in response to the window display request triggered on the virtual game interface, the virtual game interface displayed on the client interface with the game floating window, and displaying the second picture in the game floating window, restore the displaying of the virtual game interface on the client interface when the idle game event ends.

For specific embodiments, refer to the examples shown in the above game picture display method. Details will not be elaborated here in this example.

As a non-limiting example, the apparatus further includes:
a tenth display unit, configured to: after displaying the virtual game interface on the client interface and displaying the first picture on the virtual game interface, display window prompt information in response to a preliminary window request triggered on the virtual game interface, the window prompt information being configured for prompting to prepare to display the game floating window;
an eleventh display unit, configured to: after displaying the virtual game interface on the client interface and displaying the first picture on the virtual game interface, display the game floating window on the client interface in response to a secondary window request triggered on the window prompt information;
or a twelfth display unit is configured to: after displaying the virtual game interface on the client interface and displaying the first picture on the virtual game interface, display a background application interface on the client interface in response to a third window request triggered on the window prompt information, at least one application that is run in a background being displayed on the background application interface, and the at least one application including an application of the virtual game.

For specific embodiments, refer to the examples shown in the above game picture display method. Details will not be elaborated here in this example.

As a non-limiting example, the apparatus further includes:
a voice unit, configured to: after replacing, in response to a window display request triggered on the virtual game interface, the virtual game interface displayed on the client interface with the game floating window, and displaying the second picture in the game floating window, prompt key information of a key node by voice in a case that the key node is triggered in the game process of the virtual game.

For specific embodiments, refer to the examples shown in the above game picture display method. Details will not be elaborated here in this example.

According to another aspect of the embodiments of this disclosure, an electronic device for implementing the above game picture display method is further provided. The electronic device may be, but is not limited to, the user device 102 or the server 112 shown in FIG. 1. In this embodiment, an example in which the electronic device is the user device 102 is used for description. Further, as shown in FIG. 22, the electronic device includes a memory 2202 and processing circuitry such as a processor 2204. The memory 2202 has a computer program stored therein, and the processor 2204 is configured to perform operations in any one of the above method embodiments through the computer program.

In this embodiment, the electronic device may be located in at least one network device of a plurality of network devices in a computer network.

In some embodiments, the processor may be configured to perform any method in the above embodiments through the computer program.

In some embodiments, a person of ordinary skill in the art may understand that, a structure shown in FIG. 22 is only illustrative, and a structure of the above electronic device is not limited in FIG. 22. For example, the electronic device may further include more or fewer components (for example, a network interface) than those shown in FIG. 22, or has a configuration different from that shown in FIG. 22.

The memory 2202 may be configured to store software programs and modules, for example, program instructions/modules corresponding to the game picture display method and apparatus in the embodiments of this disclosure. The processor 2204 runs the software programs and the modules that are stored in the memory 2202, to perform various functional applications and data processing, namely, to implement the above game picture display method. The memory 2202 may include a high-speed random memory, and may further include a non-volatile memory, for example, one or more magnetic storage apparatuses, a flash memory, or another nonvolatile solid-state memory. In some embodiments, the memory 2202 may further include memories remotely disposed relative to the processor 2204, and these remote memories may be connected to the electronic device through a network. Examples of the above network include, but are not limited to, Internets, intranets, local area networks, mobile communication networks, and combinations thereof. The memory 2202 may be specifically, but is not limited to, configured to store information such as a virtual game interface, a first picture, and a second picture. As an example, as shown in FIG. 22, the memory 2202 may include, but is not limited to, the first display unit 2102 and the second display unit 2104 in the above game picture display apparatus. In addition, the memory 2202 may further include, but is not limited to, another module unit in the above game picture display apparatus. This is not described again in this example.

In one embodiment, a transmission apparatus 2206 is configured to receive or send data through a network. Specific examples of the above network may include a wired network and a wireless network. In an example, the transmission apparatus 2206 includes a network interface controller (NIC). The NIC may be connected to another network device and a router through a network cable, so as to communicate with the Internet or a local area network. In an example, the transmission apparatus 2206 is a radio frequency (RF) module, which communicates with the Internet in a wireless manner.

In addition, the above electronic device further includes: a display 2208, configured to display the above information such as the virtual game picture, the first picture, and the second picture; and a connection bus 2210, configured to connect the module components in the electronic device.

In other embodiments, the user device or the server may be a node in a distributed system. The distributed system may be a blockchain system. The blockchain system may be a distributed system formed by a plurality of nodes connected in a form of network communication. A peer to peer network may be formed between the nodes. A computing device in any form, such as the server, the user device, and another electronic device, may become a node in the blockchain system by joining the peer-to-peer network.

According to an aspect in this disclosure, a computer program product is provided. The computer program product includes a computer program. The computer program includes a program code for performing the method shown in the flowchart. In such an embodiment, the computer program may be downloaded and installed from a network through a communication part, and/or installed from a removable medium. When the computer program is executed by a central processing unit, the functions provided by this embodiment of this disclosure are performed.

The sequential numbers of the foregoing embodiments of this disclosure are merely for description purposes but do not imply the preference of the embodiments.

A computer system of the electronic device is merely an example, and does not constitute any limitation on functions and use ranges of the embodiments of this disclosure.

The computer system includes a central processing unit (CPU), which may perform various suitable actions and processing based on a program stored in a read-only memory (ROM) or a program loaded from a storage part into a random access memory (RAM). The random access memory further stores various programs and data that are required for system operations. The central processing unit, the read-only memory, and the random access memory are connected to each other through a bus. An input/output interface (i.e. an I/O interface) is also connected to the bus.

The following components are connected to the I/O interface: an input part including a keyboard, a mouse, and the like; an output part such as a cathode ray tube (CRT), a liquid crystal display (LCD), and a speaker; a storage part including a hard disk drive; and a communication part including a network interface card such as a local area network card and a modem. The communication part performs communication processing by using a network such as the Internet. A driver is also connected to the I/O interface as needed. A removable medium, such as a magnetic disk, an optical disc, a magneto-optical disk, or a semiconductor memory, is installed on the driver as required, so that a computer program read from the removable medium is installed into the storage part as required.

Particularly, according to the embodiments of this disclosure, the processes described in the method flowcharts may be implemented as computer software programs. For example, the embodiments of this disclosure include a computer program product, including a computer program carried on a non-transitory computer-readable medium, and the computer program includes program codes used for performing the methods shown in the flowcharts. In such an embodiment, the computer program may be downloaded and installed from a network through a communication part, and/or installed from a removable medium. When the computer program is executed by the central processing unit, the various functions defined in the system of this disclosure are executed.

According to an aspect of this disclosure, a non-transitory computer-readable storage medium is provided. A processor of a computer device reads a computer program or instructions from the non-transitory computer-readable storage medium and executes the computer program or instructions, causing the computer device to perform the method provided in various examples.

In some embodiments, the non-transitory computer-readable storage medium may be configured to store a computer program or instructions for performing any method in the above embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In this embodiment, a person of ordinary skill in the art may understand that all or some of the operations of various methods in the above embodiments may be implemented by a program instructing relevant hardware of an electronic device. The program may be stored in a non-transitory computer-readable storage medium. The storage medium may include: a flash disk, a read-only memory (ROM), a random access memory (RAM), a magnetic disk, an optical disc, or the like.

The sequential numbers of the foregoing embodiments of this disclosure are merely for description purposes but do not imply the preference of the embodiments.

When the integrated unit in the above embodiments is implemented in a form of a software functional unit and sold or used as an independent product, the integrated unit may be stored in the above non-transitory computer-readable storage medium. Based on such an understanding, the technical solutions of this disclosure, in whole or in part, may be implemented in a form of a software product. The computer software product is stored in a storage medium and includes several instructions for causing one or more computer devices (which may be a personal computer, a server, a network device, or the like) to perform all or some of operations of the methods in the embodiments of this disclosure.

In the foregoing embodiments of this disclosure, the description of each embodiment has respective focuses. For a part that is not described in detail in an embodiment, refer to related descriptions in other embodiments.

In the several embodiments provided in this disclosure, the disclosed user equipment may be implemented in another manner. The foregoing described apparatus embodiments are merely examples. For example, the unit division is merely logical function division and there may be other division manners in practical implementations. For example, multiple units or components may be combined or integrated into another system, or some features may be omitted or not performed. In addition, the shown or discussed mutual coupling or direct coupling or communication connection is an indirect coupling or communication connection through some interfaces, units or modules, and can be electrical or in another form.

The units described as separate parts may or may not be physically separated, and parts displayed as units may or may not be physical units, that is, may be located in one position, or may be distributed on multiple network units. Some or all of the units are selected according to various factors to achieve the objective of the solution of this embodiment.

In addition, functional units in the embodiments of this disclosure may be integrated into one processing unit, or each of the units may exist alone physically, or two or more units are integrated into one unit. The integrated units mentioned above can be implemented in both a hardware form and a software functional unit form.

The foregoing descriptions are non-limiting examples of this disclosure. A person of ordinary skill in the art may make some improvements and/or modifications without departing from the principle of this disclosure, and the improvements and modifications shall fall within the scope of this disclosure.

What is claimed is:

1. A game picture display method, comprising:
displaying a virtual game interface of a virtual game on a client interface;
displaying a first picture on the virtual game interface, the first picture corresponding to a first game picture frame of the virtual game;
replacing, based on a window display request triggered on the virtual game interface, the virtual game interface displayed on the client interface with a game floating window on the client interface, a display area of the game floating window being smaller than a display area of the virtual game interface; and
displaying, by processing circuitry, a second picture in the game floating window, the second picture including a resized rendition of a second game picture frame of the virtual game and a key information indicator overlaid on the resized rendition, and the key information indicator indicating a game process of the virtual game.

2. The method according to claim 1, wherein
the key information indicator includes process prompt information indicating a running condition of at least one sub-process in the virtual game.

3. The method according to claim 2, wherein the process prompt information comprises:
first process information indicating a stage and a round to which a currently run sub-process of the virtual game belongs;
first time information indicating a remaining process time before the currently run sub-process of the virtual game ends;
second process information indicating a stage and a round to which the currently run sub-process of the virtual game belongs, and second time information indicating a remaining stage time before the stage ends, or a remaining round time before the round ends; or
third process information indicating a game event to which the currently run sub-process of the virtual game belongs, and third time information indicating a remaining event time before the game event ends.

4. The method according to claim 1, wherein the displaying the second picture in the game floating window comprises:
based on the game floating window being in a small window mode, displaying, in the game floating window, the key information indicator and a static picture corresponding to one of a plurality of game picture frames of the virtual game; and
based on the game floating window being in a large window mode, displaying, in the game floating window, the key information indicator and a video clip corresponding to a resized rendition of the plurality of game picture frames.

5. The method according to claim 4, further comprising:
displaying, based on an enlarge adjustment operation performed on the game floating window in the small window mode, the game floating window in the large window mode on the client interface, and displaying the key information indicator and the video clip in the game floating window; and
displaying, based on a shrink adjustment operation performed on the game floating window in the large window mode, the game floating window in the small window mode on the client interface, and displaying the key information indicator and the static picture in the game floating window.

6. The method according to claim 4, further comprising:
adjusting a display area or a display position of the game floating window on the client interface based on change to a display resource available to the game floating window;
displaying, based on an adjusted display area of the game floating window being greater than a reference window area, the game floating window in the large window mode on the client interface, and displaying the key information indicator and the video clip in the game floating window in the large window mode; and
displaying, based on the adjusted display area of the game floating window being less than or equal to the reference window area, the game floating window in the small window mode on the client interface, and displaying the key information indicator and the static pictures in the game floating window in the small window mode.

7. The method according to claim 4, wherein the replacing the virtual game interface with the game floating window comprises:
displaying, based on the window display request being triggered for the first time on the virtual game interface, the game floating window in a default mode on the client interface, the default mode being the small window mode or the large window mode;
based on the window display request not being triggered for the first time, and the game floating window being in the small window mode at an end of display of the game floating window based on a previous triggered window request, displaying the game floating window in the small window mode on the client interface; and
based on the window display request not being triggered for the first time, and the game floating window being in the large window mode at the end of the display of the game floating window based on the previous triggered window request, displaying the game floating window in the large window mode on the client interface.

8. The method according to claim 1, further comprising:
displaying event prompt information in the game floating window based on a game event occurring in the virtual game, the event prompt information indicating occurrence of the game event.

9. The method according to claim 8, wherein the displaying the event prompt information comprises:
displaying a to-be-viewed label in the game floating window, the to-be-viewed label indicating that the game event is in a to-be-viewed state;
displaying the virtual game interface on the client interface based on a display restoration request triggered on the game floating window; and
displaying, on the virtual game interface, a third game picture frame in which the game event occurs, the game event being set to a viewed state.

10. The method according to claim 1, further comprising:
displaying a window setting interface on the virtual game interface, the window setting interface corresponding to setting a display function of the game floating window; and
setting, based on a function enabling request triggered on the window setting interface, the display function of the game floating window to be in an enabled state that corresponds to the window display request being allowed to be triggered on the virtual game interface.

11. The method according to claim 10, further comprising, based on the display function of the game floating window being in the enabled state:
triggering the window display request based on an interface exit operation performed on the virtual game interface or an interface jump operation performed on another application interface.

12. The method according to claim 1, further comprising:
displaying a virtual waiting control element associated with an idle game event on the virtual game interface based on the idle game event occurring in the virtual game, the idle game event corresponding to a game event that is allowed to be detached from an active operation in the virtual game; and
triggering the window display request based on a selection operation performed on the virtual waiting control element.

13. The method according to claim 12, wherein
the key information indicator includes key information of the idle game event, and
the method further comprises:
restoring the displaying of the virtual game interface on the client interface when the idle game event ends.

14. The method according to claim 1, further comprising:
displaying window prompt information based on a preliminary window request triggered on the virtual game interface, the window prompt information indicating preparation of replacing the virtual game interface; and
performing one of:
displaying the game floating window on the client interface based on a secondary window request triggered on the window prompt information; or
displaying a background application interface on the client interface based on a third window request triggered on the window prompt information, at least one application that is executed in a background being displayed on the background application interface, and the at least one application including an application of the virtual game.

15. The method according to claim 1, further comprising:
playing a voice notification indicating key information of a key node of the virtual game based on the key node being triggered according to a game process of the virtual game.

16. A game picture display apparatus, comprising:
processing circuitry configured to:
display a virtual game interface of a virtual game on a client interface;
display a first picture on the virtual game interface, the first picture corresponding to a first game picture frame of the virtual game;
replace, based on a window display request triggered on the virtual game interface, the virtual game interface displayed on the client interface with a game floating window on the client interface, a display area of the game floating window being smaller than a display area of the virtual game interface; and
display a second picture in the game floating window, the second picture including a resized rendition of a second game picture frame of the virtual game and a key information indicator overlaid on the resized rendition, and the key information indicator indicating a game process of the virtual game.

17. The game picture display apparatus according to claim 16, wherein
the key information indicator includes process prompt information indicating a running condition of at least one sub-process in the virtual game.

18. The game picture display apparatus according to claim 17, wherein the process prompt information comprises:
first process information indicating a stage and a round to which a currently run sub-process of the virtual game belongs;
first time information indicating a remaining process time before the currently run sub-process of the virtual game ends;
second process information indicating a stage and a round to which the currently run sub-process of the virtual game belongs, and second time information indicating a remaining stage time before the stage ends, or a remaining round time before the round ends; or
third process information indicating a game event to which the currently run sub-process of the virtual game belongs, and third time information indicating a remaining event time before the game event ends.

19. The game picture display apparatus according to claim 16, wherein, to display the second picture in the game floating window, the processing circuitry is configured to:
based on the game floating window being in a small window mode, display, in the game floating window, the key information indicator and a static picture corresponding to one of a plurality of game picture frames of the virtual game; and
based on the game floating window being in a large window mode, display the key information indicator and a video clip corresponding to a resized rendition of the plurality of game picture frames.

20. A non-transitory computer-readable storage medium storing instructions, which when executed by a processor, cause the processor to perform:
displaying a virtual game interface of a virtual game on a client interface;
displaying a first picture on the virtual game interface, the first picture corresponding to a first game picture frame of the virtual game;
replacing, based on a window display request triggered on the virtual game interface, the virtual game interface displayed on the client interface with a game floating window on the client interface, a display area of the game floating window being smaller than a display area of the virtual game interface; and
displaying a second picture in the game floating window, the second picture including a resized rendition of a second game picture frame of the virtual game and a key information indicator overlaid on the resized rendition, and the key information indicator indicating a game process of the virtual game.
